(19) United States
(12) Patent Application Publication
(10) Pub. No.: US 2014/0313284 A1
(43) Pub. Date: Oct. 23, 2014

(54) IMAGE PROCESSING APPARATUS, METHOD THEREOF, AND PROGRAM

(71) Applicant: Sony Corporation, Tokyo (JP)

(72) Inventors: Mitsuharu Ohki, Tokyo (JP); Tomonori Masuno, Tokyo (JP)

(73) Assignee: Sony Corporation, Tokyo (JP)

(21) Appl. No.: 14/354,959

(22) PCT Filed: Nov. 2, 2012
(86) PCT No.: PCT/JP2012/078425

§ 371 Date: Apr. 29, 2014

(30) Foreign Application Priority Data
Nov. 9, 2011 (JP) 2011-245295

(51) Int. Cl. H04N 5/232

(52) U.S. Cl. CPC H04N 5/23238
USPC 348/36

(57) ABSTRACT

This technology relates to an image processing apparatus, a method thereof, and a program making it possible to cut out an area in a desired direction of a panoramic image more easily and rapidly.

When the image processing apparatus cuts out an area in a predetermined eye direction of a panoramic image projected on a spherical surface to display, this displays an area of the panoramic image projected on a virtual screen determined by a specified eye direction as an output image. That is, the image processing apparatus calculates a pixel position of the panoramic image projected on a position on the screen by an approximation function to generate the output image. At that time, the image processing apparatus evaluates an approximation error by the approximation function. Specifically, the image processing apparatus determines a range of a writing area such that the approximation error is not larger than an allowance when this obtains the pixel position of the panoramic image corresponding to each position in the writing area on the screen by using one approximation function. This technology may be applied to the image processing apparatus.

### TECHNICAL FIELD

This technology relates to an image processing apparatus, a method thereof, and a program and especially relates to the image processing apparatus, the method thereof, and the program making it possible to more easily and rapidly cut out an area in a desired direction when an area in a specific direction of a panoramic image is cut out to be displayed.

### BACKGROUND ART

For example, technology to generate a wide panoramic image by using a plurality of images sequentially taken while rotating a camera is known (for example, refer to Patent Document 1). In order to generate such panoramic image, a part of a plurality of taken images is cut out to be synthesized.

### CITATION LIST

### Patent Documents

Patent Document 1: Japanese Patent No. 4293053

### SUMMARY OF THE INVENTION

### Problems to be Solved by the Invention

However, in the above-described technology, although it is possible to cut out a part of the panoramic image to display, it is not possible to cut out an area in a specified direction in the panoramic image to display when the desired direction is specified as an eye direction of a user.

This technology is achieved in consideration of such a circumstance and an object thereof is to easily and rapidly cut out the area in the desired direction in the panoramic image.

### Solution to Problems

An image processing apparatus according to one aspect of this technology is an image processing apparatus configured to generate an output image having predetermined positional relationship with an input image, the image processing apparatus including: an extreme value data generating unit configured to generate, based on a function required for calculating an error when a position on the input image corresponding to a position on the output image is obtained by an approximation function, the function having a variable defining the positional relationship and the position on the output image as a variable, data regarding an extreme value of the function; an error calculating unit configured to calculate, for a current area from a first position to a second position on the output image, the error when the position of the input image corresponding to a position in the current area is obtained by the approximation function based on the data; a determining unit configured to determine the current area in which the error is not larger than a predetermined threshold; and an image generating unit configured to generate the output image by obtaining the corresponding position of the input image for each position in the determined current area by using the approximation function and making a pixel value of a pixel of the corresponding position a pixel value of a pixel of the position in the current area.

It is possible to make the approximation function a polynomial approximation function obtained by polynomial expansion of a function indicating the positional relationship around the first position.

It is possible to make the approximation function an (n−1)-th order polynomial approximation function and make the function required for calculating the error a function obtained by n-th order differential of the function indicating the positional relationship.

It is possible to make the variable defining the positional relationship a direction of the output image seen from a predetermined reference position and a distance from the reference position to the output image.

It is possible to make the position on the input image corresponding to a predetermined position on the output image a position of an intersection between a straight line passing through the predetermined position and the reference position and the input image.

It is possible to make the input image an image projected on a spherical surface or an image projected on a cylindrical surface.

An image processing method or a program according to one aspect of this technology is an image processing method or a program configured to generate an output image having predetermined positional relationship with an input image including steps of: generating, based on a function required for calculating an error when a position on the input image corresponding to a position on the output image is obtained by an approximation function, the function having a variable defining the positional relationship and the position on the output image as a variable, data regarding an extreme value of the function; calculating, for a current area from a first position to a second position on the output image, the error when the position of the input image corresponding to a position in the current area is obtained by the approximation function based on the data; determining the current area in which the error is not larger than a predetermined threshold; and generating the output image by obtaining the corresponding position of the input image for each position in the determined current area by using the approximation function and making a pixel value of a pixel of the corresponding position a pixel value of a pixel of the position in the current area.

According to one aspect of this technology, when an output image having predetermined positional relationship with an input image is generated: based on a function required for calculating an error when a position on the input image corresponding to a position on the output image is obtained by an approximation function, the function having a variable defining the positional relationship and the position on the output image as a variable, data regarding an extreme value of the function is generated; for a current area from a first position to a second position on the output image, the error when the position of the input image corresponding to a position in the current area is obtained by the approximation function is calculated based on the data; the current area in which the error is not larger than a predetermined threshold is determined; and the output image generated by obtaining the corresponding position of the input image for each position in the determined current area by using the approximation function and making a pixel value of a pixel of the corresponding position a pixel value of a pixel of the position in the current area.

### Effects of the Invention

According to one aspect of this technology, it is possible to easily and rapidly cut out the area in the desired direction in the panoramic image.

### BRIEF DESCRIPTION OF DRAWINGS

FIG. 1 is a view illustrating a spherical surface on which a panoramic image is projected.

FIG. 2 is a view illustrating a cylindrical surface on which the panoramic image is projected.

FIG. 3 is a view of a pseudo code for cutting out a desired area of the panoramic image.

FIG. 4 is a view of a pseudo code for cutting out the desired area of the panoramic image.

FIG. 5 is a view illustrating a screen on which a part of the panoramic image is projected.

FIG. 6 is a view of a pseudo code to obtain a value when an n-th order differential function takes an extreme value.

FIG. 7 is a view of a pseudo code to obtain the value when the n-th order differential function takes the extreme value.

FIG. 8 is a view of a pseudo code to obtain the value when the n-th order differential function takes the extreme value.

FIG. 9 is a view of a pseudo code to obtain the value when the n-th order differential function takes the extreme value.

FIG. 10 is a view of a configuration example of an image processing apparatus.

FIG. 11 is a flowchart illustrating an image outputting process.

FIG. 12 is a flowchart illustrating an end position calculating process.

FIG. 13 is a flowchart illustrating a writing process.

FIG. 14 is a view of a configuration example of an image processing apparatus.

FIG. 15 is a flowchart illustrating an image outputting process.

FIG. 16 is a flowchart illustrating an end position calculating process.

FIG. 17 is a flowchart illustrating a writing process.

FIG. 18 is a view illustrating a configuration example of a computer.

### MODE FOR CARRYING OUT THE INVENTION

Embodiments to which this technology is applied are hereinafter described with reference to the drawings.

<Summary of Technology>

[Regarding Panoramic Image]

First, a summary of this technology is described.

In general, a wide panoramic image is not often generated as an image projected on a plane by perspective projection transformation. This is because a peripheral portion of the panoramic image is extremely distorted and an image wider than 180 degrees cannot be represented. Therefore, usually, the panoramic image is often saved as an image projected on a spherical surface or an image projected on a cylindrical surface.

Therefore, the panoramic image projected on the spherical surface and the panoramic image projected on the cylindrical surface are first described.

In a case where the panoramic image is the image projected on the spherical surface, a width and a height of the panoramic image (two-dimensional image) are 2π and π, respectively. That is, when an arbitrary position on a coordinate system (hereinafter, referred to as an SxSy coordinate system) of the two-dimensional image is represented as (Sx, Sy), the panoramic image is the image having a rectangular area satisfying 0≦Sx≦2π and −π/2≦Sy≦π/2.

Light coming from a direction represented by following equation (1) toward an original point in a three-dimensional XwYwZw coordinate system (hereinafter, also referred to as a world coordinate system) is projected on each position (Sx, Sy) of the two-dimensional image.

$$\begin{matrix}[ Equation 1 ] & \\ [ \begin{matrix}Xw \\ Yw \\ Zw\end{matrix} ] = [ \begin{matrix}sin ( Sx ) \times cos ( Sy ) \\ sin ( Sy ) \\ cos ( Sx ) \times cos ( Sy )\end{matrix} ] & ( 1 )\end{matrix}$$

Meanwhile, in equation (1), Xw, Yw, and Zw represent an Xw coordinate, a Yw coordinate, and a Zw coordinate in the world coordinate system, respectively.

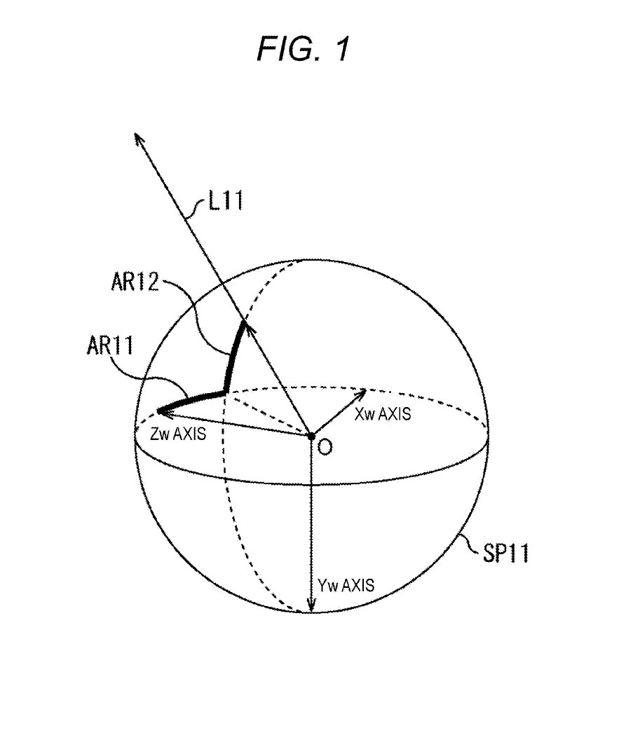

That is, an image obtained by developing a spherical surface SP11 having a radius of 1 with an original point O of the world coordinate system as the center as illustrated in FIG. 1 by using equidistant cylindrical projection is the panoramic image (two-dimensional image). Meanwhile, in FIG. 1, a right oblique direction, a downward direction, and a left oblique direction indicate directions of an Xw axis, a Yw axis, and a Zw axis of the world coordinate system, respectively.

In an example in FIG. 1, a position at which the Zw axis and the spherical surface SP11 intersect with each other is an original point of the SxSy coordinate system. Therefore, lengths of a circular arc AR11 and a circular arc AR12 on the spherical surface SP11 are Sx and Sy, respectively. A direction of a straight line L11 passing through the original point O of the world coordinate system is the direction represented by equation (1).

On the other hand, when the panoramic image is the image projected on the cylindrical surface, a width and a height of the panoramic image (two-dimensional image) are 2π and an arbitrary height H, respectively. That is, when an arbitrary position on a coordinate system (hereinafter, referred to as a CxCy coordinate system) of the two-dimensional image is represented as (Cx, Cy), the panoramic image is the image having a rectangular area satisfying 0≦Cx≦2π and −H/2≦Cy≦H/2.

Light coming from a direction represented by following equation (2) toward the original point in the three-dimensional XwYwZw coordinate system (world coordinate system) is projected on each position (Cx, Cy) of the two-dimensional image.

$$\begin{matrix}[ Equation 2 ] & \\ [ \begin{matrix}Xw \\ Yw \\ Zw\end{matrix} ] = [ \begin{matrix}sin ( Cx ) \\ Cy \\ cos ( Cx )\end{matrix} ] & ( 2 )\end{matrix}$$

Meanwhile, in equation (2), Xw, Yw, and Zw represent the Xw coordinate, the Yw coordinate, and the Xw coordinate in the world coordinate system, respectively.

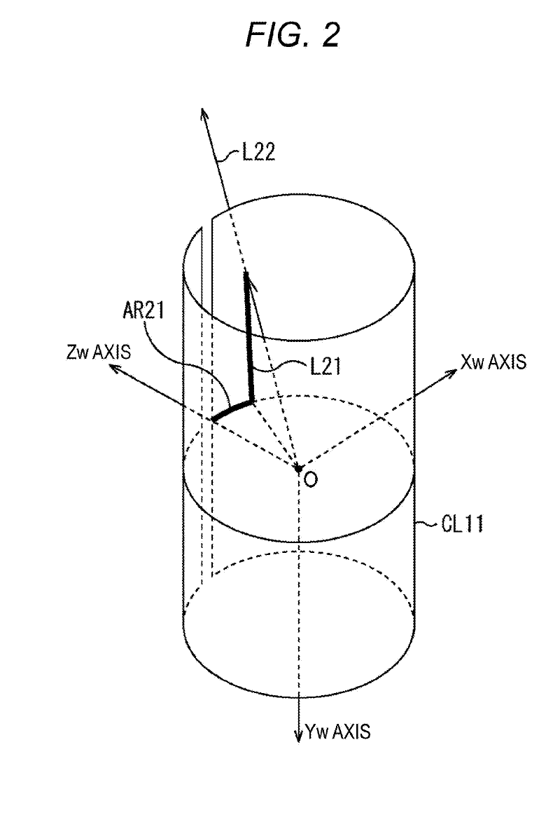

That is, an image obtained by developing a cylindrical surface CL11 being a side surface of a cylinder having a radius of 1 with the Yw axis of the world coordinate system as the center as illustrated in FIG. 2 is the panoramic image (two-dimensional image). Meanwhile, in FIG. 2, a right oblique direction, a downward direction, and a left oblique direction indicate directions of the Xw axis, the Yw axis, and the Zw axis of the world coordinate system, respectively.

In an example in FIG. 2, a position at which the Zw axis and the cylindrical surface CL11 intersect with each other is an original point of the CxCy coordinate system. Therefore, lengths of a circular arc AR21 and a straight line L21 on the cylindrical surface CL11 are Cx and Cy, respectively. A direction of a straight line L22 passing through the original point O of the world coordinate system is the direction represented by equation (2).

[Regarding Cutout Display of Panoramic Image]

There is demand to view the panoramic image while cutting out a part of such wide panoramic image and displaying the same on a display device.

Suppose that the number of pixels in a transverse direction (direction corresponding to an Sx direction or a Cx direction) of a display screen of the display device on which the image cut out from the panoramic image is displayed is Wv and the number of pixels in a longitudinal direction (direction corresponding to an Sy direction or a Cy direction) of the display screen is Hv.

For example, Wv=800 and Hv=600, and the numbers of pixels Wv and Hv are fixed values. The numbers of pixels Wv and Hv are even numbers.

A user specifies an area of the panoramic image to be displayed when allowing the display device to display a part of the panoramic image. Specifically, an eye direction of the user determined by two angles θ_{yaw} and θ_{pitch} and a focal distance Fv, for example, are specified by the user.

When the eye direction and the focal distance of the user are specified in this manner, an area in the eye direction in the panoramic image is displayed at a zoom magnification determined by the focal distance.

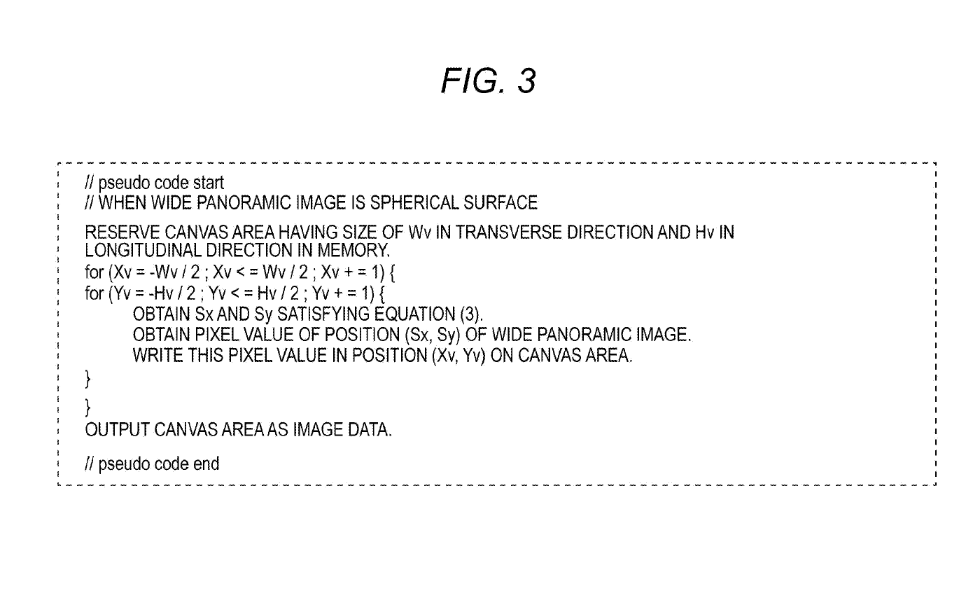

Specifically, in a case where the wide panoramic image is the image projected on the spherical surface, a pseudo code illustrated in FIG. 3 is executed and the image is displayed on the display device.

That is, a canvas area having a size of Wv in the transverse direction and Hv in the longitudinal direction is reserved in a memory. The position (Sx, Sy) on the panoramic image satisfying following equation (3) is obtained for each position (Xv, Yv) (wherein, −Wv/2≦Xv≦Wv/2 and −Hv/2≦Yv≦Hv/2 are satisfied) of the XvYv coordinate system on the canvas area.

$$\begin{matrix}[ Equation 3 ] & \\ [ \begin{matrix}sin ( Sx ) \times cos ( Sy ) \\ sin ( Sy ) \\ cos ( Sx ) \times cos ( Sy )\end{matrix} ] ∝ [ \begin{matrix}cos ( {θ}_{yaw} ) & 0 & sin ( {θ}_{yaw} ) \\ 0 & 1 & 0 \\ - sin ( {θ}_{yaw} ) & 0 & cos ( {θ}_{yaw} )\end{matrix} ] [ \begin{matrix}1 & 0 & 0 \\ 0 & cos ( {θ}_{pitch} ) & - sin ( {θ}_{pitch} ) \\ 0 & sin ( {θ}_{pitch} ) & cos ( {θ}_{pitch} )\end{matrix} ] [ \begin{matrix}Xv \\ Yv \\ Fv\end{matrix} ] & ( 3 )\end{matrix}$$

When the position (Sx, Sy) on the panoramic image corresponding to each position (Xv, Yv) on the XvYv coordinate system is obtained, a pixel value of a pixel of the panoramic image in the position (Sx, Sy) is written in the corresponding position (Xv, Yv) on the canvas area. That is, the pixel value of the pixel in the position (Sx, Sy) of the panoramic image is made the pixel value of the pixel in the corresponding position (Xv, Yv) on the canvas area.

When the pixel value is written in each position on the canvas area in this manner, an image on the canvas area is output as an image of the area in the eye direction with the focal distance specified by the user on the panoramic image.

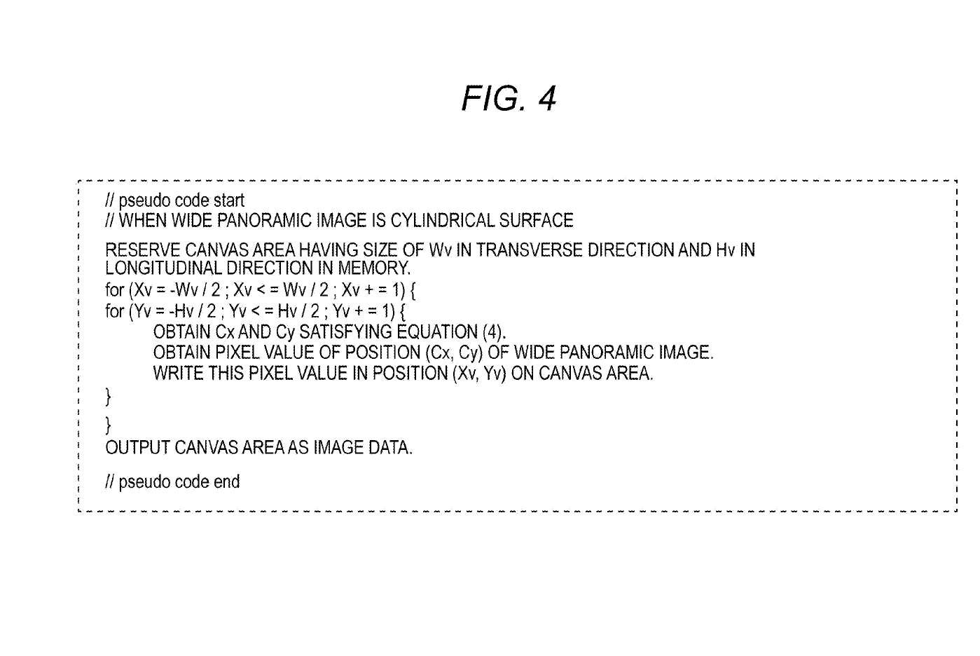

Similarly, when the wide panoramic image is the image projected on the cylindrical surface, a pseudo code illustrated in FIG. 4 is executed and the image is displayed on the display device.

That is, a canvas area having a size of Wv in the transverse direction and Hv in the longitudinal direction is reserved in a memory. The position (Cx, Cy) on the panoramic image satisfying following equation (4) is obtained for each position (Xv, Yv) (wherein −Wv/2≦Xv≦Wv/2 and −Hv/2≦Yv≦Hv/2 are satisfied) of the XvYv coordinate system on the canvas area.

$$\begin{matrix}[ Equation 4 ] & \\ [ \begin{matrix}sin ( Cx ) \\ Cy \\ cos ( Cx )\end{matrix} ] ∝ [ \begin{matrix}cos ( {θ}_{yaw} ) & 0 & sin ( {θ}_{yaw} ) \\ 0 & 1 & 0 \\ - sin ( {θ}_{yaw} ) & 0 & cos ( {θ}_{yaw} )\end{matrix} ] [ \begin{matrix}1 & 0 & 0 \\ 0 & cos ( {θ}_{pitch} ) & - sin ( {θ}_{pitch} ) \\ 0 & sin ( {θ}_{pitch} ) & cos ( {θ}_{pitch} )\end{matrix} ] [ \begin{matrix}Xv \\ Yv \\ Fv\end{matrix} ] & ( 4 )\end{matrix}$$

When the position (Cx, Cy) on the panoramic image corresponding to each position (Xv, Yv) on the XvYv coordinate system is obtained, the pixel value of the pixel of the panoramic image in the position (Cx, Cy) is written in the corresponding position (Xv, Yv) on the canvas area.

When the pixel value is written in each position on the canvas area in this manner, an image on the canvas area is output as an image of the area in the eye direction with the focal distance specified by the user on the panoramic image.

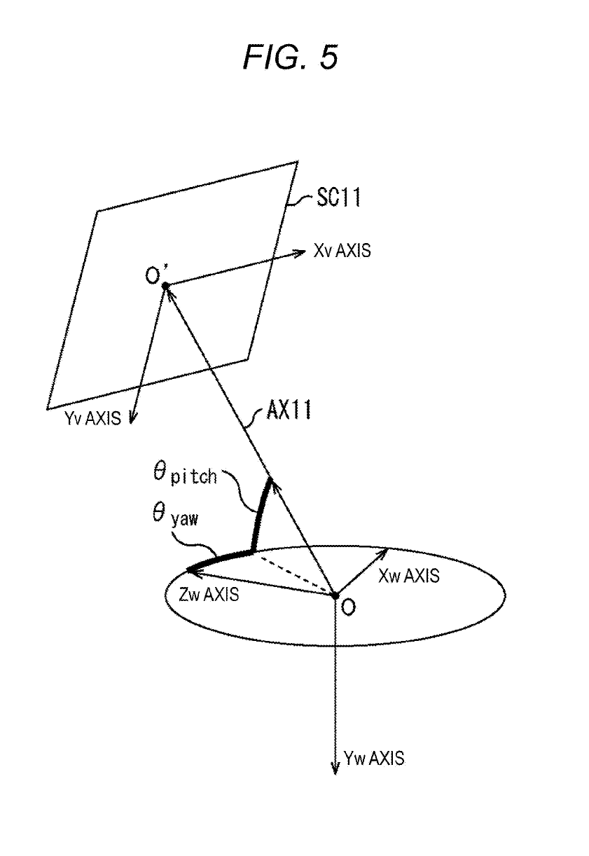

The image obtained by the pseudo code illustrated in FIG. 3 or 4 is an image illustrated in FIG. 5, for example. Meanwhile, a right diagonal direction, a downward direction, and a left diagonal direction in the drawing indicate the Xw axis direction, the Yw axis direction, and the Zw axis direction of the world coordinate system, respectively.

In FIG. 5, a virtual screen SC11 is provided in a space on the world coordinate system, the screen SC11 corresponding to the canvas area reserved in the memory when the pseudo code in FIG. 3 or 4 is executed. In this example, an original point O′ of the XvYv coordinate system based on the screen SC11 (canvas area) is located on the center of the screen SC11.

An axis AX11 obtained by rotating a straight line passing through the original point O of the world coordinate system so as to be parallel to the Zw axis around the Yw axis by the angle θ_{yaw} and further rotating the same by the angle θ_{pitch} relative to an XwZw plane is herein considered. The axis AX11 is a straight line connecting the original point O of the world coordinate system and the original point O′ of the XvYv coordinate system and a length of the axis AX11, that is, a distance from the original point O to the original point O′ is the focal distance Fv. If a viewpoint of the user is located on the original point O, a direction of the axis AX11 is in the eye direction determined by the angle θ_{yaw} and the angle θ_{pitch} specified by the user, that is, a direction in which the screen SC11 is located.

Therefore, when the user specifies the eye direction determined by the angle θ_{yaw} and the angle θ_{pitch} and the focal distance Fv, this means that the user specifies the position of the screen SC11 on which the image cut out from the panoramic image is displayed.

The screen SC11 is a plane orthogonal to the axis AX11 having a size of Wv in the transverse direction and Hv in the longitudinal direction. That is, in the XvYv coordinate system, an area within a range of −Wv/2≦Xv≦Wv/2 and −Hv/2≦Yv≦Hv/2 becomes an area (effective area) of the screen SC11.

Herein, an arbitrary position (Xv, Yv) on the screen SC11 on the XvYv coordinate system is represented by following equation (5) on the world coordinate system.

$$\begin{matrix}[ Equation 5 ] & \\ [ \begin{matrix}cos ( {θ}_{yaw} ) & 0 & sin ( {θ}_{yaw} ) \\ 0 & 1 & 0 \\ - sin ( {θ}_{yaw} ) & 0 & cos ( {θ}_{yaw} )\end{matrix} ] [ \begin{matrix}1 & 0 & 0 \\ 0 & cos ( {θ}_{pitch} ) & - sin ( {θ}_{pitch} ) \\ 0 & sin ( {θ}_{pitch} ) & cos ( {θ}_{pitch} )\end{matrix} ] [ \begin{matrix}Xv \\ Yv \\ Fv\end{matrix} ] & ( 5 )\end{matrix}$$

As described above, the light coming from the direction represented by equation (1) in the world coordinate system toward the original point O of the world coordinate system is projected on each position (Sx, Sy) on the wide panoramic image in the SxSy coordinate system. Similarly, the light coming from the direction represented by equation (2) toward the original point O in the world coordinate system is projected on each position (Cx, Cy) on the panoramic image in the CxCy coordinate system.

Therefore, determining the pixel value of the pixel of each position (Xv, Yv) on the screen SC11 by equation (3) or (4) is the equivalent of projecting the light coming from a certain direction toward the original point O in the world coordinate system on a position at which this intersects with the screen SC11.

Therefore, the image output by execution of the pseudo code illustrated in FIG. 3 or 4 is just like the image (panoramic image) projected on the screen SC11. That is, the user may view the image (landscape) projected on the virtual screen SC11 on the display device by specifying the eye direction determined by the angle θ_{yaw} and the angle θ_{pitch} and the focal distance Fv. The image projected on the screen SC11, that is, the image displayed on the display device is the image of a partial area of the panoramic image cut out from the wide panoramic image.

Meanwhile, when a value of the focal distance Fv is made larger, the image as if taken by using a telephoto lens is displayed on the display device, and when the value of the focal distance Fv is made smaller, the image as if taken by using a wide-angle lens is displayed on the display device.

As is understood from the description above, the angle θ_{yaw} is not smaller than 0 degree and smaller than 360 degrees and the angle θ_{pitch} is not smaller than −90 degrees and smaller than 90 degrees. Further, a possible value of the focal distance Fv is not smaller than 0.1 and not larger than 10, for example.

[Regarding this Technology]

In order to cut out a partial area from the panoramic image to display on the display device, equation (3) or (4) described above should be calculated for each position (Xv, Yv) of the screen SC11 (canvas area) in the XvYv coordinate system. However, this is complicated calculation requiring an operation of a trigonometric function and division. Therefore, an operational amount is enormous and a processing speed slows down.

Therefore, in this technology, calculation of polynomial approximation is performed for realizing a smaller operational amount of the calculation to obtain the area of the panoramic image projected on each position of the screen and improvement in the processing speed. Further, at the time of the operation, it is configured to evaluate an error by approximation such that a worst error by the approximation calculation is not larger than a desired threshold, thereby presenting a high-quality image.

In other words, this technology makes it possible to cut out a partial area from the wide panoramic image to display by simple calculation by decreasing the operational amount in the pseudo code illustrated in FIG. 3 or 4.

Since it is required to perform the complicated calculation in order to cut out a partial area of the panoramic image, it is tried to improve the processing speed by simplifying the calculation by the polynomial approximation in this technology; however, the polynomial approximation is just the approximation, so that a calculation error occurs in the calculation by the polynomial approximation.

In this technology, the polynomial approximation is applied to the calculation performed when the above-described pseudo code illustrated in FIG. 3 or 4 is executed.

That is, in the vicinity of a predetermined position (Xv, Yv) on the screen (canvas area) in the XvYv coordinate system, the calculation is performed by certain polynomial approximation. When the calculation error in the polynomial approximation becomes large to a certain degree, that is, when the calculation error exceeds a predetermined threshold, the calculation is performed by another polynomial approximation from a position at which the calculation error exceeds a predetermined threshold.

For example, when the polynomial approximation is applied to the calculation when the pseudo code illustrated in FIG. 3 or 4 is executed, quality of an image obtained by high-speed processing by the polynomial approximation might be deteriorated due to the calculation error if it is not possible to specify a position at which the calculation error exceeds the threshold. That is, there is a possibility that a finally obtained image is not an appropriate image.

Therefore, in this technology, the calculation error by the polynomial approximation is evaluated and the polynomial approximation used in the calculation is changed according to the evaluation. According to this, it becomes possible to easily and rapidly cut out an area in a desired direction in the panoramic image and to present a higher-quality image as the cut out image.

[Regarding Polynomial Approximation]

The polynomial approximation (Taylor expansion) is described before this technology is described.

Relationship represented by following equation (6) is established for a differentiable arbitrary function G(L). That is, equation (6) is obtained by the Tailor expansion of the function G(L).

$$\begin{matrix}[ Equation 6 ] & \\ {}^{∀} L , {}_{}^{∃}{L}{}_{1}^{} ∈ ( 0 , L ) \\ s . t . \\ G ( {L}_{0} + L ) = G ( {L}_{0} ) + {G}^{( 1 )} ( {L}_{0} ) \times \frac{L}{1} + {G}^{( 2 )} ( {L}_{0} ) \times \frac{{L}^{2}}{2 !} + … + {G}^{( n - 1 )} ( {L}_{0} ) \times \frac{{L}^{( n - 1 )}}{( n - 1 ) !} + {G}^{( n )} ( {L}_{0} + {L}_{1} ) \times \frac{{L}^{n}}{n !} & ( 6 )\end{matrix}$$

Herein, a function Ga(L) obtained by (n−1)-th order polynomial approximation of the function G(L) is the function represented by following equation (7).

$$\begin{matrix}[ Equation 7 ] & \\ Ga ( {L}_{0} + L ) ≡ G ( {L}_{0} ) + {G}^{( 1 )} ( {L}_{0} ) \times \frac{L}{1} + {G}^{( 2 )} ( {L}_{0} ) \times \frac{{L}^{2}}{2 !} + … + {G}^{( n - 1 )} ( {L}_{0} ) \times \frac{{L}^{( n - 1 )}}{( n - 1 ) !} & ( 7 )\end{matrix}$$

It is possible to derive following equation (8) from equations (6) and (7). That is, equation (8) represents an error between the function G(L) and the function Ga(L) obtained by the (n−1)-th order polynomial approximation of the function G(L).

$$\begin{matrix}[ Equation 8 ] & \\ \vert G ( {L}_{0} + L ) - Ga ( {L}_{0} + L ) \vert \leq {max}_{0 < {L}_{1} < L} ( \vert {G}^{( n )} ( {L}_{0} + {L}_{1} ) \vert ) \times \frac{{L}^{n}}{n !} & ( 8 )\end{matrix}$$

Following equation (9) is established for arbitrary 0<L₂≦L.

$$\begin{matrix}[ Equation 9 ] & \\ {max}_{0 < {L}_{1} < {L}_{2}} ( \vert {G}^{( n )} ( {L}_{0} + {L}_{1} ) \vert ) \times \frac{{L}^{n}}{n !} \leq {max}_{0 < {L}_{1} < L} ( \vert {G}^{( n )} ( {L}_{0} + {L}_{1} ) \vert ) \times \frac{{L}^{n}}{n !} & ( 9 )\end{matrix}$$

Therefore, when predetermined L of the function G(L) satisfies following equation (10), even when the function Ga(L) being an approximation function is used in place of the function G(L), the calculation error by the approximation is no more than ε in every position in a closed interval [0, L].

$$\begin{matrix}[ Equation 10 ] & \\ {max}_{0 < {L}_{1} < L} ( \vert {G}^{( n )} ( {L}_{0} + {L}_{1} ) \vert ) \times \frac{{L}^{n}}{n !} = ɛ & ( 10 )\end{matrix}$$

Taylor's theorem is described as above.

[Regarding Application of Polynomial Approximation]

Next, a case where the Taylor's theorem is applied to equations (3) and (4) described above is considered. Meanwhile, in a following description, n is a fixed value of approximately 3 or 4, for example.

First, following equation (11) is obtained by transforming equation (3) described above.

$$\begin{matrix}[ Equation 11 ] & \\ [ \begin{matrix}sin ( Sx ) \times cos ( Sy ) \\ sin ( Sy ) \\ cos ( Sx ) \times cos ( Sy )\end{matrix} ] ∝ [ \begin{matrix}cos ( {θ}_{yaw} ) & 0 & sin ( {θ}_{yaw} ) \\ 0 & 1 & 0 \\ - sin ( {θ}_{yaw} ) & 0 & cos ( {θ}_{yaw} )\end{matrix} ] [ \begin{matrix}1 & 0 & 0 \\ 0 & cos ( {θ}_{pitch} ) & - sin ( {θ}_{pitch} ) \\ 0 & sin ( {θ}_{pitch} ) & cos ( {θ}_{pitch} )\end{matrix} ] [ \begin{matrix}Xv / Fv \\ Yv / Fv \\ 1\end{matrix} ] & ( 11 )\end{matrix}$$

Similarly, following equation (12) is obtained by transforming equation (4) described above.

$$\begin{matrix}[ Equation 12 ] & \\ [ \begin{matrix}sin ( Cx ) \\ Cy \\ cos ( Cx )\end{matrix} ] ∝ [ \begin{matrix}cos ( {θ}_{yaw} ) & 0 & sin ( {θ}_{yaw} ) \\ 0 & 1 & 0 \\ - sin ( {θ}_{yaw} ) & 0 & cos ( {θ}_{yaw} )\end{matrix} ] [ \begin{matrix}1 & 0 & 0 \\ 0 & cos ( {θ}_{pitch} ) & - sin ( {θ}_{pitch} ) \\ 0 & sin ( {θ}_{pitch} ) & cos ( {θ}_{pitch} )\end{matrix} ] [ \begin{matrix}Xv / Fv \\ Yv / Fv \\ 1\end{matrix} ] & ( 12 )\end{matrix}$$

Meanwhile, each of equations (3) and (4) is the equation representing proportional relationship and the proportional relationship is maintained even when only elements of a right side of the equation are divided by the focal distance Fv, so that equations (11) and (12) are derived.

In equation (11), Sx and Sy are functions of (Xv/Fv), (Yv/Fv), θ_{yaw}, and θ_{pitch}, so that they are clearly represented by following equation (13).

$$\begin{matrix}[ Equation 13 ] & \\ Sx = Sx ( \frac{Xv}{Fv} , \frac{Yv}{Fv} , {θ}_{yaw} , {θ}_{pitch} ) , \\ Sy = Sy ( \frac{Xv}{Fv} , \frac{Yv}{Fv} , {θ}_{yaw} , {θ}_{pitch} ) & ( 13 )\end{matrix}$$

Similarly, in equation (12), Cx and Cy are functions of (Xv/Fv), (Yv/Fv), θ_{yaw} and θ_{pitch}, so that they are clearly represented by following equation (14).

$$\begin{matrix}[ Equation 14 ] & \\ Cx = Cx ( \frac{Xv}{Fv} , \frac{Yv}{Fv} , {θ}_{yaw} , {θ}_{pitch} ) , \\ Cy = Cy ( \frac{Xv}{Fv} , \frac{Yv}{Fv} , {θ}_{yaw} , {θ}_{pitch} ) & ( 14 )\end{matrix}$$

Relationship of following equation (15) may be derived from equation (11) described above, so that relationship of following equation (16) is established.

$$\begin{matrix}[ Equation 15 ] & \\ [ \begin{matrix}1 & 0 & 0 \\ 0 & cos ( {θ}_{pitch} ) & - sin ( {θ}_{pitch} ) \\ 0 & sin ( {θ}_{pitch} ) & cos ( {θ}_{pitch} )\end{matrix} ] [ \begin{matrix}Xv / Fv \\ Yv / Fv \\ 1\end{matrix} ] ∝ {[ \begin{matrix}cos ( {θ}_{yaw} ) & 0 & sin ( {θ}_{yaw} ) \\ 0 & 1 & 0 \\ - sin ( {θ}_{yaw} ) & 0 & cos ( {θ}_{yaw} )\end{matrix} ]}^{- 1} [ \begin{matrix}sin ( Sx ) \times cos ( Sy ) \\ sin ( Sy ) \\ cos ( Sx ) \times cos ( Sy )\end{matrix} ] = [ \begin{matrix}cos ( {θ}_{yaw} ) & 0 & - sin ( {θ}_{yaw} ) \\ 0 & 1 & 0 \\ sin ( {θ}_{yaw} ) & 0 & cos ( {θ}_{yaw} )\end{matrix} ] [ \begin{matrix}sin ( Sx ) \times cos ( Sy ) \\ sin ( Sy ) \\ cos ( Sx ) \times cos ( Sy )\end{matrix} ] = [ \begin{matrix}\begin{matrix}cos ( {θ}_{yaw} ) \times sin ( Sx ) \times cos ( Sy ) - \\ sin ( {θ}_{yaw} ) \times cos ( Sx ) \times cos ( Sy )\end{matrix} \\ sin ( Sy ) \\ \begin{matrix}sin ( {θ}_{yaw} ) \times sin ( Sx ) \times cos ( Sy ) \times \\ cos ( {θ}_{yaw} ) \times cos ( Sx ) \times cos ( Sy )\end{matrix}\end{matrix} ] = [ \begin{matrix}sin ( Sx - {θ}_{yaw} ) \times cos ( Sy ) \\ sin ( Sy ) \\ cos ( Sx - {θ}_{yaw} ) \times cos ( Sy )\end{matrix} ] & ( 15 ) \\ [ Equation 16 ] & \\ Sx ( \frac{Xv}{Fv} , \frac{Yv}{Fv} , {θ}_{yaw} , {θ}_{pitch} ) = Sx ( \frac{Xv}{Fv} , \frac{Yv}{Fv} , 0 , {θ}_{pitch} ) + {θ}_{yaw} , \\ Sy ( \frac{Xv}{Fv} , \frac{Yv}{Fv} , {θ}_{yaw} , {θ}_{pitch} ) = Sy ( \frac{Xv}{Fv} , \frac{Yv}{Fv} , 0 , {θ}_{pitch} ) & ( 16 )\end{matrix}$$

Similarly, relationship of following equation (17) may be derived from equation (12) described above, so that relationship of following equation (18) is established.

$$\begin{matrix}[ Equation 17 ] & \\ [ \begin{matrix}1 & 0 & 0 \\ 0 & cos ( {θ}_{pitch} ) & - sin ( {θ}_{pitch} ) \\ 0 & sin ( {θ}_{pitch} ) & cos ( {θ}_{pitch} )\end{matrix} ] [ \begin{matrix}Xv / Fv \\ Yv / Fv \\ 1\end{matrix} ] ∝ {[ \begin{matrix}cos ( {θ}_{yaw} ) & 0 & sin ( {θ}_{yaw} ) \\ 0 & 1 & 0 \\ - sin ( {θ}_{yaw} ) & 0 & cos ( {θ}_{yaw} )\end{matrix} ]}^{- 1} [ \begin{matrix}sin ( Cx ) \\ Cy \\ cos ( Cx )\end{matrix} ] = [ \begin{matrix}cos ( {θ}_{yaw} ) & 0 & - sin ( {θ}_{yaw} ) \\ 0 & 1 & 0 \\ sin ( {θ}_{yaw} ) & 0 & cos ( {θ}_{yaw} )\end{matrix} ] [ \begin{matrix}sin ( Cx ) \\ Cy \\ cos ( Cx )\end{matrix} ] = [ \begin{matrix}cos ( {θ}_{yaw} ) \times sin ( Cx ) - sin ( {θ}_{yaw} ) \times cos ( Cx ) \\ Cy \\ sin ( {θ}_{yaw} ) \times sin ( Cx ) \times cos ( {θ}_{yaw} ) \times cos ( Cx )\end{matrix} ] = [ \begin{matrix}sin ( Cx - {θ}_{yaw} ) \\ Cy \\ cos ( Cx - {θ}_{yaw} )\end{matrix} ] & ( 17 ) \\ [ Equation 18 ] & \\ Cx ( \frac{Xv}{Fv} , \frac{Yv}{Fv} , {θ}_{yaw} , {θ}_{pitch} ) = Cx ( \frac{Xv}{Fv} , \frac{Yv}{Fv} , 0 , {θ}_{pitch} ) + {θ}_{yaw} , \\ Cy ( \frac{Xv}{Fv} , \frac{Yv}{Fv} , {θ}_{yaw} , {θ}_{pitch} ) = Cy ( \frac{Xv}{Fv} , \frac{Yv}{Fv} , 0 , {θ}_{pitch} ) & ( 18 )\end{matrix}$$

Herein, functions Us(x, y, θ) and Vs(x, y, θ) defined by following equation (19) and functions Uc(x, y, θ) and Vc(x, y, θ) defined by equation (20) are considered.

$$\begin{matrix}[ Equation 19 ] & \\ [ \begin{matrix}sin ( Us ( x , y , θ ) ) \times cos ( Vs ( x , y , θ ) ) \\ sin ( Vs ( x , y , θ ) ) \\ cos ( Us ( x , y , θ ) ) \times cos ( Vs ( x , y , θ ) )\end{matrix} ] ∝ [ \begin{matrix}1 & 0 & 0 \\ 0 & cos ( θ ) & - sin ( θ ) \\ 0 & sin ( θ ) & cos ( θ )\end{matrix} ] [ \begin{matrix}x \\ y \\ 1\end{matrix} ] \\ where \\ - ∞ < x < ∞ , - ∞ < y < ∞ , - \frac{π}{2} < θ < \frac{π}{2} . & ( 19 ) \\ [ Equation 20 ] & \\ [ \begin{matrix}sin ( Uc ( x , y , θ ) ) \\ Vc ( x , y , θ ) \\ cos ( Uc ( x , y , θ ) )\end{matrix} ] ∝ [ \begin{matrix}1 & 0 & 0 \\ 0 & cos ( θ ) & - sin ( θ ) \\ 0 & sin ( θ ) & cos ( θ )\end{matrix} ] [ \begin{matrix}x \\ y \\ 1\end{matrix} ] \\ where \\ - ∞ < x < ∞ , - ∞ < y < ∞ , - \frac{π}{2} < θ < \frac{π}{2} . & ( 20 )\end{matrix}$$

When equations (11) and (19) in a case where angle θ_{yaw}=0 are compared with each other and equation (16) is further taken into consideration, following equation (21) is derived.

$$\begin{matrix}[ Equation 21 ] & \\ Sx ( \frac{Xv}{Fv} , \frac{Yv}{Fv} , {θ}_{yaw} , {θ}_{pitch} ) = Us ( \frac{Xv}{Fv} , \frac{Yv}{Fv} , {θ}_{pitch} ) + {θ}_{yaw} , \\ Sy ( \frac{Xv}{Fv} , \frac{Yv}{Fv} , {θ}_{yaw} , {θ}_{pitch} ) = Vs ( \frac{Xv}{Fv} , \frac{Yv}{Fv} , {θ}_{pitch} ) & ( 21 )\end{matrix}$$

Similarly, when equations (12) and (20) in a case where the angle θ_{yaw}=0 are compared with each other and equation (18) is further taken into consideration, following equation (22) is derived.

$$\begin{matrix}[ Equation 22 ] & \\ Cx ( \frac{Xv}{Fv} , \frac{Yv}{Fv} , {θ}_{yaw} , {θ}_{pitch} ) = Uc ( \frac{Xv}{Fv} , \frac{Yv}{Fv} , {θ}_{pitch} ) + {θ}_{yaw} , \\ Cy ( \frac{Xv}{FV} , \frac{Yv}{Fv} , {θ}_{yaw} , {θ}_{pitch} ) = Vc ( \frac{Xv}{Fv} , \frac{Yv}{Fv} , {θ}_{pitch} ) & ( 22 )\end{matrix}$$

Further, when the Taylor's theorem is applied to a first equation in equation (21), that is, a function Sx(Xv/Fv, Yv/Fv, θ_{yaw}, θ_{pitch}) r following equation (23) is obtained.

$$\begin{matrix}[ Equation 23 ] & \\ Sx ( \frac{Xv}{Fv} , \frac{{Yv}_{1}}{Fv} , {θ}_{yaw} , {θ}_{pitch} ) = \{ {θ}_{yaw} + Us ( x , y , θ ) {\vert}_{{{x = Xv / Fv }_{y = {Yv}_{0} / Fv}}_{θ = {θ}_{pitch} }} \} + \{ \frac{\partial Us ( x , y , θ )}{\partial y} {\vert}_{{{x = Xv / Fv }_{y = {Yv}_{0} / Fv}}_{θ = {θ}_{pitch} }} \times \frac{( {Yv}_{1} - {Yv}_{0} )}{Fv} \} + \{ \frac{{\partial }^{2} Us ( x , y , θ )}{\partial {y}^{2}} {\vert}_{{x = Xv / Fv }_{{y = {Yv}_{0} / Fv}_{θ = {θ}_{pitch} }}} \times \frac{{( {Yv}_{1} - {Yv}_{0} )}^{2}}{2 ! \times {Fv}^{2}} \} + … + \{ \frac{{\partial }^{n - 1} Us ( x , y , θ )}{\partial {y}^{n - 1}} {\vert}_{{x = Xv / Fv }_{{y = {Yv}_{0} / Fv}_{θ = {θ}_{pitch} }}} \times \frac{{( {Yv}_{1} - {Yv}_{0} )}^{n - 1}}{( n - 1 ) ! \times {Fv}^{n - 1}} \} + \{ \frac{{\partial }^{n} Us ( x , y , θ )}{\partial {y}^{n}} {\vert}_{{x = Xv / Fv }_{{y = {Yv}_{2} / Fv}_{θ = {θ}_{pitch} }}} \times \frac{{( {Yv}_{1} - {Yv}_{0} )}^{n}}{n ! \times {Fv}^{n}} \} & ( 23 )\end{matrix}$$

Meanwhile, equation (23) is obtained by the Taylor expansion of the function Sx(Xv/Fv, Yv/Fv, θ_{yaw}, θ_{pitch}) around Yv₀ for a variable Yv. In equation (23), Yv₂ is an appropriate value in an open interval (Yv₀, Yv₁).

Therefore, when the function Sx(Xv/Fv, Yv/Fv, θ_{yaw}, θ_{pitch}) is approximated by a polynomial represented by following equation (24) for specific Xv, specific Fv, specific θ_{yaw}, specific θ_{pitch}, and an arbitrary value of Yv in the closed interval [Yv₀, Yv₁], an error by the approximation never exceeds a value represented by equation (25).

$$\begin{matrix}[ Equation 24 ] & \\ \{ {θ}_{yaw} + Us ( x , y , θ ) {\vert}_{{x = Xv / Fv }_{{y = {Yv}_{0} / Fv}_{θ = {θ}_{pitch} }}} \} + \{ \frac{\partial Us ( x , y , θ )}{\partial y} {\vert}_{{x = Xv / Fv }_{{y = {Yv}_{0} / Fv}_{θ = {θ}_{pitch} }}} \times \frac{( Yv - {Yv}_{0} )}{Fv} \} + \{ \frac{{\partial }^{2} Us ( x , y , θ )}{\partial {y}^{2}} {\vert}_{{x = Xv / Fv }_{{y = {Yv}_{0} / Fv}_{θ = {θ}_{pitch} }}} \times \frac{{( Yv - {Yv}_{0} )}^{2}}{2 ! \times {Fv}^{2}} \} + … + \{ \frac{{\partial }^{n - 1} Us ( x , y , θ )}{\partial {y}^{n - 1}} {\vert}_{{x = Xv / Fv }_{{y = {Yv}_{0} / Fv}_{θ = {θ}_{pitch} }}} \times \frac{{( Yv - {Yv}_{0} )}^{n - 1}}{( n - 1 ) ! \times {Fv}^{n - 1}} \} & ( 24 ) \\ [ Equation 25 ] & \\ {max}_{{Yv}_{0} < {Yv}_{2} < {Yv}_{1}} ( \vert \frac{{\partial }^{n} Us ( x , y , θ )}{\partial {y}^{n}} {\vert}_{{x = Xv / Fv }_{{y = {Yv}_{2} / Fv}_{θ = {θ}_{pitch} }}} \vert ) \times \frac{{\vert {Yv}_{1} - {Yv}_{0} \vert}^{n}}{n ! \times {Fv}^{n}} & ( 25 )\end{matrix}$$

Meanwhile, a function represented by equation (24) is an (n−1)-th order polynomial approximation function obtained by polynomial expansion of a first equation in equation (21) around Yv₀.

The same is true for Sy, Cx, and Cy as well as for Sx.

That is, when the function Sy(Xv/Fv, Yv/Fv, θ_{yaw}, θ_{pitch}) of equation (21) is approximated by a polynomial represented by following equation (26) for specific Xv, specific Fv, specific θ_{yaw}, specific θ_{pitch}, and an arbitrary value of Yv in the closed interval [Yv₀, Yv₁], an error by the approximation never exceeds a value represented by equation (27).

$$\begin{matrix}[ Equation 26 ] & \\ \{ Vs ( x , y , θ ) {\vert}_{{x = Xv / Fv }_{{y = {Yv}_{0} / Fv}_{θ = {θ}_{pitch} }}} \} + \{ \frac{\partial Vs ( x , y , θ )}{\partial y} {\vert}_{{x = Xv / Fv }_{{y = {Yv}_{0} / Fv}_{θ = {θ}_{pitch} }}} \times \frac{( Yv - {Yv}_{0} )}{Fv} \} + \{ \frac{{\partial }^{2} Vs ( x , y , θ )}{\partial {y}^{2}} {\vert}_{{x = Xv / Fv }_{{y = {Yv}_{0} / Fv}_{θ = {θ}_{pitch} }}} \times \frac{{( Yv - {Yv}_{0} )}^{2}}{2 ! \times {Fv}^{2}} \} + … + \{ \frac{{\partial }^{n - 1} Vs ( x , y , θ )}{\partial {y}^{n - 1}} {\vert}_{{x = Xv / Fv }_{{y = {Yv}_{0} / Fv}_{θ = {θ}_{pitch} }}} \times \frac{{( Yv - {Yv}_{0} )}^{n - 1}}{( n - 1 ) ! \times {Fv}^{n - 1}} \} & ( 26 ) \\ [ Equation 27 ] & \\ {max}_{{Yv}_{0} < {Yv}_{2} < {Yv}_{1}} ( \vert \frac{{\partial }^{n} Vs ( x , y , θ )}{\partial {y}^{n}} {\vert}_{{x = Xv / Fv }_{{y = {Yv}_{2} / Fv}_{θ = {θ}_{pitch} }}} \vert ) \times \frac{{\vert {Yv}_{1} - {Yv}_{0} \vert}^{n}}{n ! \times {Fv}^{n}} & ( 27 )\end{matrix}$$

When the function Cx(Xv/Fv, Yv/Fv, θ_{yaw}, θ_{pitch}) of equation (22) is approximated by a polynomial represented by following equation (28) for specific Xv, specific Fv, specific θ_{yaw}, specific θ_{pitch}, and an arbitrary value of Yv in the closed interval [Yv₀, Yv₁], an error by the approximation never exceeds a value represented by equation (29).

$$\begin{matrix}[ Equation 28 ] & \\ \{ {θ}_{yaw} + Uc ( x , y , θ ) {\vert}_{{x = Xv / Fv }_{{y = {Yv}_{0} / Fv}_{θ = {θ}_{pitch} }}} \} + \{ \frac{\partial Uc ( x , y , θ )}{\partial y} {\vert}_{{x = Xv / Fv }_{{y = {Yv}_{0} / Fv}_{θ = {θ}_{pitch} }}} \times \frac{( Yv - {Yv}_{0} )}{Fv} \} + \{ \frac{{\partial }^{2} Uc ( x , y , θ )}{\partial {y}^{2}} {\vert}_{{x = Xv / Fv }_{{y = {Yv}_{0} / Fv}_{θ = {θ}_{pitch} }}} \times \frac{{( Yv - {Yv}_{0} )}^{2}}{2 ! \times {Fv}^{2}} \} + … + \{ \frac{{\partial }^{n - 1} Uc ( x , y , θ )}{\partial {y}^{n - 1}} {\vert}_{{x = Xv / Fv }_{{y = {Yv}_{0} / Fv}_{θ = {θ}_{pitch} }}} \times \frac{{( Yv - {Yv}_{0} )}^{n - 1}}{( n - 1 ) ! \times {Fv}^{n - 1}} \} & ( 28 ) \\ [ Equation 29 ] & \\ {max}_{{Yv}_{0} < {Yv}_{2} < {Yv}_{1}} ( \vert \frac{{\partial }^{n} Uc ( x , y , θ )}{\partial {y}^{n}} {\vert}_{{x = Xv / Fv }_{{y = {Yv}_{2} / Fv}_{θ = {θ}_{pitch} }}} \vert ) \times \frac{{\vert {Yv}_{1} - {Yv}_{0} \vert}^{n}}{n ! \times {Fv}^{n}} & ( 29 )\end{matrix}$$

Further, when the function Cy(Xv/Fv, Yv/Fv, θ_{yaw}, θ_{pitch}) of equation (22) is approximated by a polynomial represented by following equation (30) for specific Xv, specific Fv, specific θ_{yaw}, specific θ_{pitch}, and an arbitrary value of Yv in the closed interval [Yv₀, Yv₁], an error by the approximation never exceeds a value represented by equation (31).

$$\begin{matrix}[ Equation 30 ] & \\ \{ Vc ( x , y , θ ) {\vert}_{{x = Xv / Fv }_{{y = {Yv}_{0} / Fv}_{θ = {θ}_{pitch} }}} \} + \{ \frac{\partial Vc ( x , y , θ )}{\partial y} {\vert}_{{x = Xv / Fv }_{{y = {Yv}_{0} / Fv}_{θ = {θ}_{pitch} }}} \times \frac{( Yv - {Yv}_{0} )}{Fv} \} + \{ \frac{{\partial }^{2} Vc ( x , y , θ )}{\partial {y}^{2}} {\vert}_{{x = Xv / Fv }_{{y = {Yv}_{0} / Fv}_{θ = {θ}_{pitch} }}} \times \frac{{( Yv - {Yv}_{0} )}^{2}}{2 ! \times {Fv}^{2}} \} + … + \{ \frac{{\partial }^{n - 1} Vc ( x , y , θ )}{\partial {y}^{n - 1}} {\vert}_{{x = Xv / Fv }_{{y = {Yv}_{0} / Fv}_{θ = {θ}_{pitch} }}} \times \frac{{( Yv - {Yv}_{0} )}^{n - 1}}{( n - 1 ) ! \times {Fv}^{n - 1}} \} & ( 30 ) \\ [ Equation 31 ] & \\ {max}_{{Yv}_{0} < {Yv}_{2} < {Yv}_{1}} ( \vert \frac{{\partial }^{n} Vc ( x , y , θ )}{\partial {y}^{n}} {\vert}_{{x = Xv / Fv }_{{y = {Yv}_{2} / Fv}_{θ = {θ}_{pitch} }}} \vert ) \times \frac{{\vert {Yv}_{1} - {Yv}_{0} \vert}^{n}}{n ! \times {Fv}^{n}} & ( 31 )\end{matrix}$$

[Listing of Extreme Value of Each Function]

In a function obtained by differentiating partially the function Us(x, y, θ) defined by equation (19) n times with respect to y, an extreme value when x and θ are fixed and y is a variable is considered.

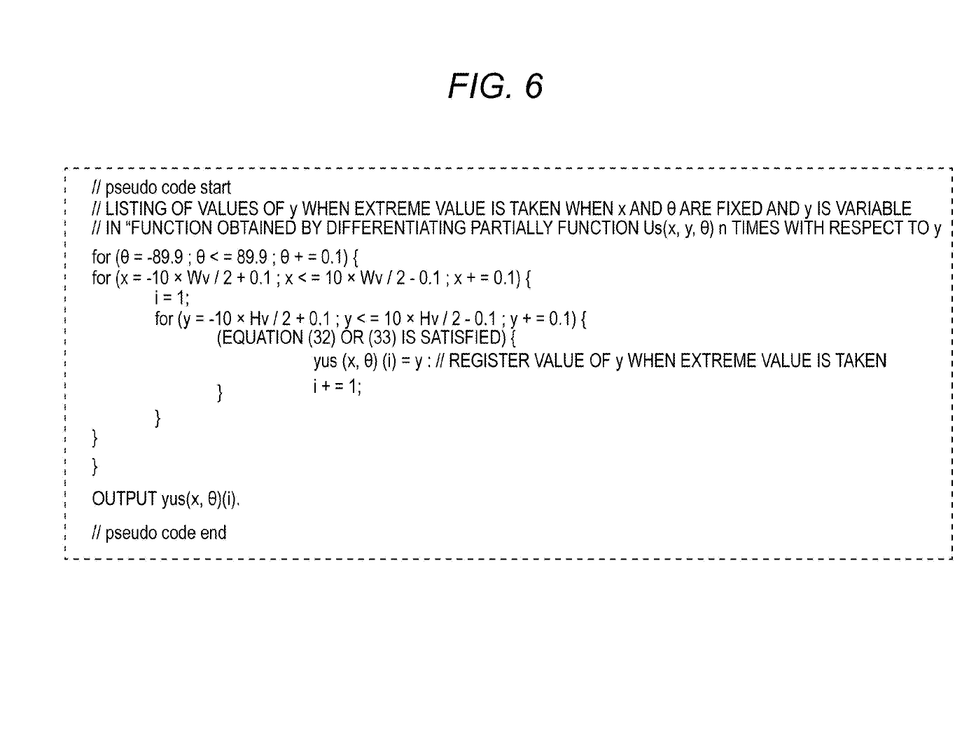

That is, suppose that all values of y when an n-th order differential function of the function Us(x, y, θ) takes the extreme value are listed by execution of a pseudo code illustrated in FIG. 6. Specifically, the value of y when the n-th order differential function of the function Us(x, y, θ) satisfies following equation (32) or (33) is registered as a value yus(x, θ)(i) of y when the extreme value is taken for each group of x and θ.

$$\begin{matrix}[ Equation 32 ] & \\ \frac{{\partial }^{n} Us ( x , y , θ )}{\partial {y}^{n}} {\vert}_{{x = x }_{{y = y - 0.1}_{θ = θ }}} < \frac{{\partial }^{n} Us ( x , y , θ )}{\partial {y}^{n}} {\vert}_{{x = x}_{{y = y}_{θ = θ}}} > \frac{{\partial }^{n} Us ( x , y , θ )}{\partial {y}^{n}} {\vert}_{{x = x }_{{y = y + 0.1}_{θ = θ }}} & ( 32 ) \\ [ Equation 33 ] & \\ \frac{{\partial }^{n} Us ( x , y , θ )}{\partial {y}^{n}} {\vert}_{{x = x }_{{y = y - 0.1}_{θ = θ }}} > \frac{{\partial }^{n} Us ( x , y , θ )}{\partial {y}^{n}} {\vert}_{{x = x}_{{y = y}_{θ = θ}}} < \frac{{\partial }^{n} Us ( x , y , θ )}{\partial {y}^{n}} {\vert}_{{x = x }_{{y = y + 0.1}_{θ = θ }}} & ( 33 )\end{matrix}$$

At that time, a value of θ being the fixed value is determined so as to change in increments of 0.1 within a range of −89.9≦θ≦89.9, that is, from −89.9 to 89.9.

A value of x being the fixed value is determined so as to change in increments of 0.1 within a range of −10×(Wv/2)+0.1≦x≦10×(Wv/2)−0.1, that is, from −10×(Wv/2)+0.1 to 10×(Wv/2)−0.1. Further, the value of y being the variable is determined so as to change in increments of 0.1 within a range of −10×(Hv/2)+0.1≦y≦10×(Hv/2)−0.1, that is, from −10×(Hv/2)+0.1 to 10×(Hv/2)−0.1. Herein, Wv for determining the value of x and Hv for determining the value of y are a width (width in an Xv axis direction) and a height (height in a Yv axis direction) of the screen SC11 on which a partial area of the panoramic image is projected.

Meanwhile, a value i in the value yus(x, θ)(i) of y when the n-th order differential function of the function Us(x, y, θ) takes the extreme value indicates order of the extreme value in ascending order taken at the value of y. That is, the number of values of y when the extreme value is taken when y is the variable is not limited to one regarding the function obtained by differentiating partially the function Us(x, y, θ) n times with respect to y for predetermined fixed values x and θ, so that the order of the extreme value is represented by a subscript “i”.

Therefore, regarding the n-th order differential function of the function Us(x, y, θ) with respect to y, when y is the variable, the values of y when the n-th order differential function takes the extreme value are yus(x, θ)(1), yus(x, θ)(2), yus(x, θ)(3), and so on.

Although the increment of the values x, y, and θ is 0.1 in this example, the increment of the values is not limited to 0.1 but may be any value. Although calculation accuracy of the value yus(x, θ)(i) improves as the increment of the values is smaller, the increment of the values is desirably approximately 0.1 for avoiding an enormous data amount of the listed values yus(x, θ)(i).

Further, it is also possible that only the value yus(x, θ)(i) of y when the n-th order differential function takes the extreme value is registered or that the value yus(x, θ)(i) and the extreme value at that time are registered. Hereinafter, it is described supposing that the value yus(x, θ)(i) and the extreme value at that time are registered.

The values yus(x, θ)(i) of y when the n-th order differential function of the function Us(x, y, θ) takes the extreme value for each fixed value x and θ listed in the above-described manner are used for calculating a maximum value of an approximation error of Sx represented by equation (25) described above.

As in the case of the function Us(x, y, θ), regarding each of the function Vs(x, y, θ) defined by equation (19) and the functions Uc(x, y, θ) and Vc(x, y, θ) defined by equation (20) also, it is considered to list the values of y when the n-th order differential function with respect to the variable y of the function takes the extreme value.

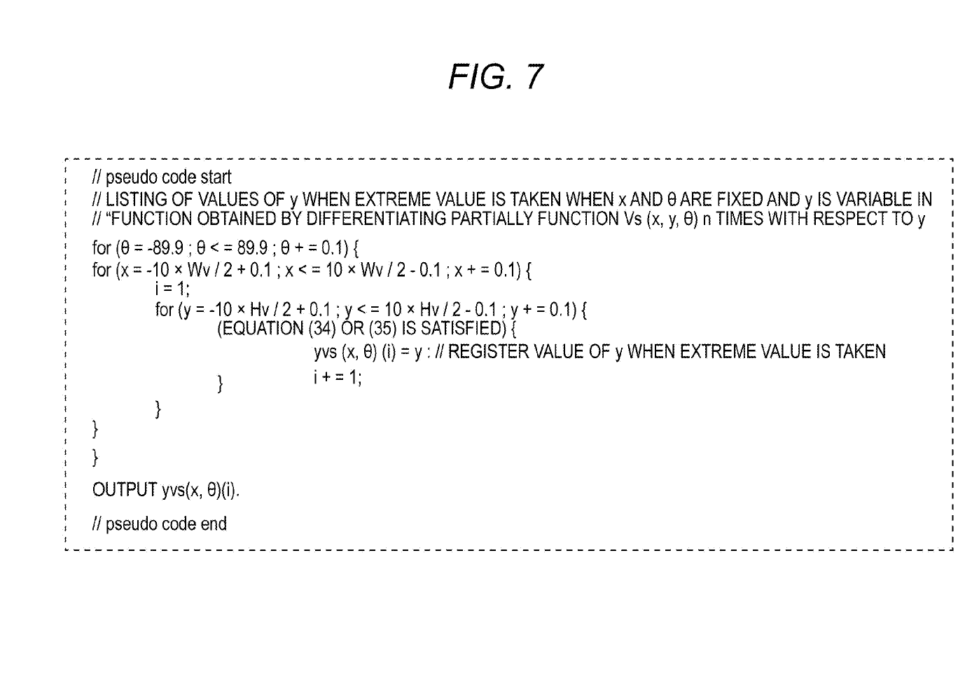

That is, in an n-th order differential function obtained by differentiating partially the function Vs(x, y, θ) n times with respect to y, suppose that all values of y when the n-th order differential function takes the extreme value when x and θ are fixed and y is the variable are listed by execution of a pseudo code illustrated in FIG. 7.

Specifically, the value of y when the n-th order differential function of the function Vs(x, y, θ) satisfies following equation (34) or (35) is registered as a value yvs(x, θ)(i) of y when the extreme value is taken for each x and θ. In more detail, the value yvs(x, θ)(i) and the extreme value at that time are registered.

$$\begin{matrix}[ Equation 34 ] & \\ \frac{{\partial }^{n} Vs ( x , y , θ )}{\partial {y}^{n}} {\vert}_{{x = x }_{{y = y - 0.1}_{θ = θ }}} < \frac{{\partial }^{n} Vs ( x , y , θ )}{\partial {y}^{n}} {\vert}_{{x = x}_{{y = y}_{θ = θ}}} > \frac{{\partial }^{n} Vs ( x , y , θ )}{\partial {y}^{n}} {\vert}_{{x = x }_{{y = y + 0.1}_{θ = θ }}} & ( 34 ) \\ [ Equation 35 ] & \\ \frac{{\partial }^{n} Vs ( x , y , θ )}{\partial {y}^{n}} {\vert}_{{x = x }_{{y = y - 0.1}_{θ = θ }}} > \frac{{\partial }^{n} Vs ( x , y , θ )}{\partial {y}^{n}} {\vert}_{{x = x}_{{y = y}_{θ = θ}}} < \frac{{\partial }^{n} Vs ( x , y , θ )}{\partial {y}^{n}} {\vert}_{{x = x }_{{y = y + 0.1}_{θ = θ }}} & ( 35 )\end{matrix}$$

Herein, the value of 0 being the fixed value is determined so as to change in increments of 0.1 from −89.9 to 89.9. The value of x being the fixed value is determined so as to change in increments of 0.1 from −10×(Wv/2)+0.1 to 10×(Wv/2)−0.1, and the value of y being the variable is determined so as to change in increments of 0.1 from −10×(Hv/2)+0.1 to 10×(Hv/2)−0.1.

Meanwhile, the value i in the value yvs(x, θ)(i) of y when the n-th order differential function of the function Vs(x, y, θ) takes the extreme value indicates the order of the extreme value in ascending order taken at the value of y.

The values yvs(x, θ)(i) of y when the n-th order differential function of the function Vs(x, y, θ) takes the extreme value for each fixed value x and θ listed in the above-described manner are used for calculating the maximum value of the approximation error of Sy represented by equation (27) described above.

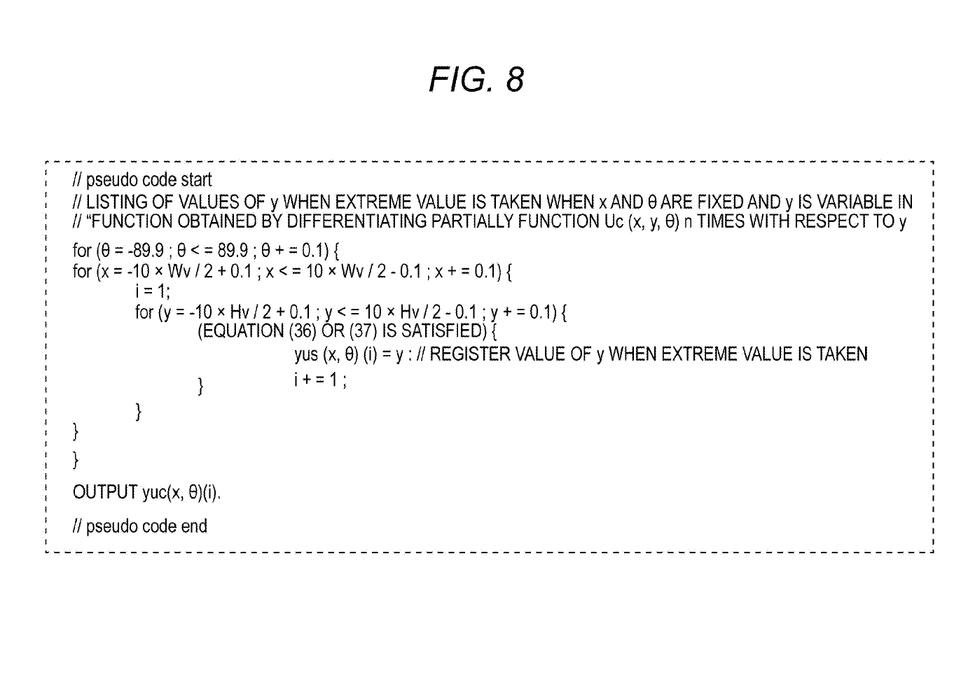

In an n-th order differential function obtained by differentiating partially the function Uc(x, y, θ) n times with respect to y, suppose that all values of y when the n-th order differential function takes the extreme value when x and θ are fixed and y is the variable are listed by execution of a pseudo code illustrated in FIG. 8.

Specifically, the value of y when the n-th order differential function of the function Uc(x, y, θ) satisfies following equation (36) or (37) is registered as a value yuc(x, θ)(i) of y when the extreme value is taken for each x and θ. In more detail, the value yuc(x, θ)(i) and the extreme value at that time are registered.

$$\begin{matrix}[ Equation 36 ] & \\ \frac{{\partial }^{n} Uc ( x , y , θ )}{\partial {y}^{n}} {\vert}_{{x = x }_{{y = y - 0.1}_{θ = θ }}} < \frac{{\partial }^{n} Uc ( x , y , θ )}{\partial {y}^{n}} {\vert}_{{x = x}_{{y = y}_{θ = θ}}} > \frac{{\partial }^{n} Uc ( x , y , θ )}{\partial {y}^{n}} {\vert}_{{x = x }_{{y = y + 0.1}_{θ = θ }}} & ( 36 ) \\ [ Equation 37 ] & \\ \frac{{\partial }^{n} Uc ( x , y , θ )}{\partial {y}^{n}} {\vert}_{{x = x }_{{y = y - 0.1}_{θ = θ }}} > \frac{{\partial }^{n} Uc ( x , y , θ )}{\partial {y}^{n}} {\vert}_{{x = x}_{{y = y}_{θ = θ}}} < \frac{{\partial }^{n} Uc ( x , y , θ )}{\partial {y}^{n}} {\vert}_{{x = x }_{{y = y + 0.1}_{θ = θ }}} & ( 37 )\end{matrix}$$

Herein, the value of θ being the fixed value is determined so as to change in increments of 0.1 from −89.9 to 89.9. The value of x being the fixed value is determined so as to change in increments of 0.1 from −10×(Wv/2)+0.1 to 10×(Wv/2)−0.1, and the value of y being the variable is determined so as to change in increments of 0.1 from −10×(Hv/2)+0.1 to 10×(Hv/2)−0.1.

Meanwhile, the value i in the value yuc(x, θ)(i) of y when the n-th order differential function of the function Uc(x, y, θ) takes the extreme value indicates the order of the extreme value in ascending order taken at the value of y.

The values yuc(x, θ)(i) of y when the n-th order differential function of the function Uc(x, y, θ) takes the extreme value for each fixed value x and θ listed in the above-described manner are used for calculating the maximum value of the approximation error of Cx represented by equation (29) described above.

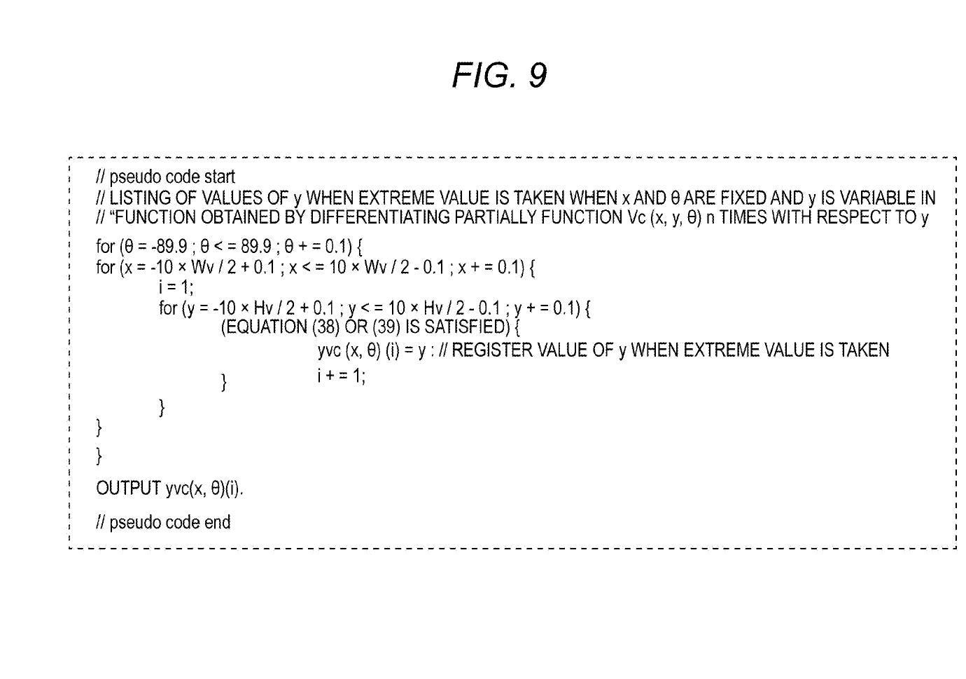

Further, in an n-th order differential function obtained by differentiating partially the function Vc(x, y, θ) n times with respect to y, suppose that all values of y when the n-th order differential function takes the extreme value when x and θ are fixed and y is the variable are listed by execution of a pseudo code illustrated in FIG. 9.

Specifically, the value of y when the n-th order differential function of the function Vc(x, y, θ) satisfies following equation (38) or (39) is registered as a value yvc(x, θ)(i) of y when the extreme value is taken for each x and θ. In more detail, the value yvc(x, θ)(i) and the extreme value at that time are registered.

$$\begin{matrix}[ Equation 38 ] & \\ \frac{{\partial }^{n} Vc ( x , y , θ )}{\partial {y}^{n}} {\vert}_{{x = x }_{{y = y - 0.1}_{θ = θ }}} < \frac{{\partial }^{n} Vc ( x , y , θ )}{\partial {y}^{n}} {\vert}_{{x = x}_{{y = y}_{θ = θ}}} > \frac{{\partial }^{n} Vc ( x , y , θ )}{\partial {y}^{n}} {\vert}_{{x = x }_{{y = y + 0.1}_{θ = θ }}} & ( 38 ) \\ [ Equation 39 ] & \\ \frac{{\partial }^{n} Vc ( x , y , θ )}{\partial {y}^{n}} {\vert}_{{x = x }_{{y = y - 0.1}_{θ = θ }}} > \frac{{\partial }^{n} Vc ( x , y , θ )}{\partial {y}^{n}} {\vert}_{{x = x}_{{y = y}_{θ = θ}}} < \frac{{\partial }^{n} Vc ( x , y , θ )}{\partial {y}^{n}} {\vert}_{{x = x }_{{y = y + 0.1}_{θ = θ }}} & ( 39 )\end{matrix}$$

Herein, the value of θ being the fixed value is determined so as to change in increments of 0.1 from −89.9 to 89.9. The value of x being the fixed value is determined so as to change in increments of 0.1 from −10×(Wv/2)+0.1 to 10×(Wv/2)−0.1, and the value of y being the variable is determined so as to change in increments of 0.1 from −10×(Hv/2)+0.1 to 10×(Hv/2)−0.1.

Meanwhile, the value i in the value yvc(x, θ)(i) of y when the n-th order differential function of the function Vc(x, y, θ) takes the extreme value indicates the order of the extreme value in ascending order taken at the value of Y.

The values yvc(x, θ)(i) of y when the n-th order differential function takes the extreme value of the function Vc(x, y, θ) for each fixed value x and θ listed in the above-described manner are used for calculating the maximum value of the approximation error of Cy represented by equation (31) described above.

[Regarding Evaluation of Approximation Error]

It becomes possible to evaluate each approximation error of Sx, Sy, Cx, and Cy by using the value when the n-th order differential function of each function takes the extreme value described above.

That is, in the closed interval [Yv₀, Yv₁], for example, the value of the approximation error of Sx represented by equation (25) described above is equal to a maximum value of three values obtained by each of following equations (40) to (42).

$$\begin{matrix}[ Equation 40 ] & \\ {max}_{i ∈ \{ i \vert \frac{{Yv}_{0}}{Fv} < yus ( xa , θa ) ( i ) < \frac{{Yv}_{1}}{Fv} \}} ( \vert \frac{{\partial }^{n} Us ( x , y , θ )}{\partial {y}^{n}} {\vert}_{{x = xa }_{{y = yus ( xa , θ a ) ( i )}_{θ = θ a }}} \vert ) \times \frac{{\vert {Yv}_{1} - {Yv}_{0} \vert}^{n}}{n ! \times {Fv}^{n}} & ( 40 ) \\ [ Equation 41 ] & \\ \vert \frac{{\partial }^{n} Us ( x , y , θ )}{\partial {y}^{n}} {\vert}_{{x = xa }_{{y = {Yv}_{0} / Fv}_{θ = θ a }}} \vert \times \frac{{\vert {Yv}_{1} - {Yv}_{0} \vert}^{n}}{n ! \times {Fv}^{n}} & ( 41 ) \\ [ Equation 42 ] & \\ \vert \frac{{\partial }^{n} Us ( x , y , θ )}{\partial {y}^{n}} {\vert}_{{x = xa }_{{y = {Yv}_{1} / Fv}_{θ = θ a }}} \vert \times \frac{{\vert {Yv}_{1} - {Yv}_{0} \vert}^{n}}{n ! \times {Fv}^{n}} & ( 42 )\end{matrix}$$

Meanwhile, in equations (40) to (42), Xa represents a predetermined value of x in 0.1 units and is a value as close to Xv/Fv as possible (the closest value). Also, θa represents a predetermined value of θ in 0.1 units and is a value as close to θ_{pitch} as possible (the closest value).

In calculation of equation (40), the values yus(x, θ)(i) listed by an operation of the pseudo code in FIG. 6 are used. That is, the calculation of equation (40) is the calculation to obtain a maximum value of absolute values of the n-th order differential function of the function Us(x, y, θ) within a range of Yv₀/Fv<y<Yv₁/Fv for fixed x=xa and θ=θa and obtain a value obtained by multiplying |Yv₁−Yv₀|ⁿ/(n!×Fvⁿ) by the obtained maximum value as an output value.

Herein, the calculation to obtain the maximum value of the absolute values of the n-th order differential function is the calculation to obtain, for values satisfying Yv₀/Fv<yus(xa, θa)(i)<Yv₁/Fv out of the listed values yus(x, θ)(i), the absolute values of the n-th order differential function at the values yus(xa, θa)(i) and further obtain the maximum value of the absolute values. The absolute value of the n-th order differential function at the value yus(xa, θa)(i) is the absolute value of the extreme value associated with the value yus(xa, θa)(i).

This is because it is only necessary to check the extreme values within a range from Yv₀ to Yv₁ when obtaining a value when the error represented by equation (25) is the maximum out of values from Yv₀ to Yv₁. That is, it is only necessary to check Yv when the error might be the maximum.

In the calculation of equation (40), the calculation is not performed for both ends of the closed interval [Yv₀, Yv₁], that is, for Yv₀ and Yv₁. Therefore, the values of the approximation error of Sx at Yv₀ and Yv₁, that is, y=Yv₀/Fv and Yv₁/Fv are also calculated by calculation of equations (41) and (42) described above.

Therefore, the maximum value out of the values obtained by the calculation of equations (40) to (42) described above is the value of the approximation error of Sx in the closed interval [Yv₀, Yv₀]. Meanwhile, although equation (40) should be normally calculated by using the extreme value when the value of x is Xv/Fv and the value of θ is θ_{pitch}, x and θ of yus(x, θ)(i) are listed only in 0.1 units, so that the extreme value is approximated by the closest yus(x, θ)(i).

It is possible to evaluate the approximation error of Sy, Cx, and Cy in the same manner as Sx.

For example, in the closed interval [Yv₀, Yv₁], the value of the approximation error of Sy represented by equation (27) described above is equal to a maximum value of three values obtained by each of following equations (43) to (45).

$$\begin{matrix}[ Equation 43 ] & \\ {max}_{i ∈ \{ i \vert \frac{{Yv}_{0}}{Fv} < yvs ( xa , θ a ) ( i ) < \frac{{Yv}_{1}}{Fv} \}} ( \vert \frac{{\partial }^{n} Vs ( x , y , θ )}{\partial {y}^{n}} {\vert}_{{x = xa }_{{y = yvs ( xa , θ a ) ( i )}_{θ = θ a }}} \vert ) \times \frac{{\vert {Yv}_{1} - {Yv}_{0} \vert}^{n}}{n ! \times {Fv}^{n}} & ( 43 ) \\ [ Equation 44 ] & \\ \vert \frac{{\partial }^{n} Vs ( x , y , θ )}{\partial {y}^{n}} {\vert}_{{x = xa }_{{y = {Yv}_{0} / Fv}_{θ = θ a }}} \vert \times \frac{{\vert {Yv}_{1} - {Yv}_{0} \vert}^{n}}{n ! \times {Fv}^{n}} & ( 4 ) \\ [ Equation 44 ] & \\ \vert \frac{{\partial }^{n} Vs ( x , y , θ )}{\partial {y}^{n}} {\vert}_{{x = xa }_{{y = {Yv}_{0} / Fv}_{θ = θ a }}} \vert \times \frac{{\vert {Yv}_{1} - {Yv}_{0} \vert}^{n}}{n ! \times {Fv}^{n}} & ( 44 ) \\ [ Equation 45 ] & \\ \vert \frac{{\partial }^{n} Vs ( x , y , θ )}{\partial {y}^{n}} {\vert}_{{x = xa }_{{y = {Yv}_{1} / Fv}_{θ = θ a }}} \vert \times \frac{{\vert {Yv}_{1} - {Yv}_{0} \vert}^{n}}{n ! \times {Fv}^{n}} & ( 45 )\end{matrix}$$

Meanwhile, in equations (43) and (44), Xa is a predetermined value of x in 0.1 units and the value as close to Xv/Fv as possible (the closest value). Also, θa represents a predetermined value of θ in 0.1 units and is a value as close to θ_{pitch} as possible (the closest value).

In the calculation of equation (43), the extreme value associated with the values yvs(x, θ)(i) listed by an operation of the pseudo code in FIG. 7 are used. That is, the calculation of equation (43) is performed by obtaining the maximum value of the absolute values of the n-th order differential function of the function Vs(x, y, θ) within the range of Yv₀/Fv<y<Yv₁/Fv for the fixed x=xa and θ=θa.

In the calculation of equation (43), the calculation is not performed for both ends of the closed interval [Yv₀, Yv₁], so that the values of the approximation error of Sy at Yv₀ and Yv₁ are also calculated by calculation of equations (44) and (45) described above. Therefore, the maximum value of values obtained by the calculation of equations (43) to (45) described above is the value of the approximation error of Sy in the closed interval [Yv₀, Yv₁].

For example, in the closed interval [Yv₀, Yv₁], the value of the approximation error of Cx represented by equation (29) described above is equal to a maximum value of three values obtained by each of following equations (46) to (48).

$$\begin{matrix}[ Equation 46 ] & \\ {max}_{i ∈ \{ i \vert \frac{{Yv}_{0}}{Fv} < yuc ( xa , θ a ) ( i ) < \frac{{Yv}_{1}}{Fv} \}} ( \vert \frac{{\partial }^{n} Uc ( x , y , θ )}{\partial {y}^{n}} {\vert}_{{x = xa }_{{y = yuc ( xa , θ a ) ( i )}_{θ = θ a }}} \vert ) \times \frac{{\vert {Yv}_{1} - {Yv}_{0} \vert}^{n}}{n ! \times {Fv}^{n}} & ( 46 ) \\ [ Equation 47 ] & \\ \vert \frac{{\partial }^{n} Uc ( x , y , θ )}{\partial {y}^{n}} {\vert}_{{x = xa }_{{y = {Yv}_{0} / Fv}_{θ = θ a }}} \vert \times \frac{{\vert {Yv}_{1} - {Yv}_{0} \vert}^{n}}{n ! \times {Fv}^{n}} & ( 47 ) \\ [ Equation 48 ] & \\ \vert \frac{{\partial }^{n} Uc ( x , y , θ )}{\partial {y}^{n}} {\vert}_{{x = xa }_{{y = {Yv}_{1} / Fv}_{θ = θ a }}} \vert \times \frac{{\vert {Yv}_{1} - {Yv}_{0} \vert}^{n}}{n ! \times {Fv}^{n}} & ( 48 )\end{matrix}$$

Meanwhile, in equations (46) to (48), Xa is a predetermined value of x in 0.1 units and the value as close to Xv/Fv as possible (the closest value). Also, θa represents a predetermined value of θ in 0.1 units and is a value as close to θ_{pitch} as possible (the closest value).

In calculation of equation (46), the extreme values associated with the values yuc(x, θ)(i) listed by an operation of the pseudo code in FIG. 8 are used. That is, the calculation of equation (46) is performed by obtaining the maximum value of the absolute values of the n-th order differential function of the function Uc(x, y, θ) within the range of Yv₀/Fv<y<Yv₁/Fy for the fixed x=xa and θ=θa.

In the calculation of equation (46), the calculation is not performed for both ends of the closed interval [Yv₀, Yv₁], so that the values of the approximation error of Cx at Yv₀ and Yv₁ are also calculated by calculation of equations (47) and (48). Therefore, the maximum value of the values obtained by the calculation of equations (46) to (48) described above is the value of the approximation error of Cx in the closed interval [Yv₀, Yv₁].

Further, in the closed interval [Yv₀, Yv₁], for example, the value of the approximation error of Cy represented by equation (31) described above is equal to a maximum value of three values obtained by each of following equations (49) to (51).

$$\begin{matrix}[ Equation 49 ] & \\ {max}_{i ∈ \{ i \vert \frac{{Yv}_{0}}{Fv} < yvc ( xa , θ a ) ( i ) < \frac{{Yv}_{1}}{Fv} \}} ( \vert \frac{{\partial }^{n} Vc ( x , y , θ )}{\partial {y}^{n}} {\vert}_{{x = xa }_{{y = yvc ( xa , θ a ) ( i )}_{θ = θ a }}} \vert ) \times \frac{{\vert {Yv}_{1} - {Yv}_{0} \vert}^{n}}{n ! \times {Fv}^{n}} & ( 49 ) \\ [ Equation 50 ] & \\ \vert \frac{{\partial }^{n} Vc ( x , y , θ )}{\partial {y}^{n}} {\vert}_{{x = xa }_{{y = {Yv}_{0} / Fv}_{θ = θ a }}} \vert \times \frac{{\vert {Yv}_{1} - {Yv}_{0} \vert}^{n}}{n ! \times {Fv}^{n}} & ( 50 ) \\ [ Equation 51 ] & \\ \vert \frac{{\partial }^{n} Vc ( x , y , θ )}{\partial {y}^{n}} {\vert}_{{x = xa }_{{y = {Yv}_{1} / Fv}_{θ = θ a }}} \vert \times \frac{{\vert {Yv}_{1} - {Yv}_{0} \vert}^{n}}{n ! \times {Fv}^{n}} & ( 51 )\end{matrix}$$

Meanwhile, in equations (49) to (51), Xa represents a predetermined value of x in 0.1 units and is the value as close to Xv/Fv as possible (the closest value). Also, θa represents a predetermined value of θ in 0.1 units and is a value as close to θ_{pitch} as possible (the closest value).

In calculation of equation (49), the extreme values associated with the values yvc(x, θ)(i) listed by an operation of the pseudo code in FIG. 9 are used. That is, the calculation of equation (49) is performed by obtaining the maximum value of the absolute values of the n-th order differential function of the function Vc(x, y, θ) within the range of Yv₀/Fv<y<Yv₁/Fv for the fixed x=xa and θ=θa.

In the calculation of equation (49), the calculation is not performed for both ends of the closed interval [Yv₀, Yv₁], so that the values of the approximation error of Cy at Yv₀ and Yv₁ are also calculated by calculation of equations (50) and (51) described above. Therefore, the maximum value of the values obtained by the calculation of equations (49) to (51) described above is the value of the approximation error of Cy in the closed interval [Yv₀, Yv₁].

The description above may be summarized as follows.

That is, when the panoramic image is the image projected on the spherical surface, the functions Us(x, y, θ) and Vs(x, y, θ) being the functions of x, y, and θ are defined by equation (19) and approximation equations of Sx and Sy being the functions of θ_{yaw}, θ_{pitch}, Fv, Xv, and Yv defined by equation (3) are considered.

Specifically, suppose that θ_{yaw}, θ_{pitch}, Fv, and Xv are fixed to arbitrary values and the function Sx is approximated by equation (24) and the function Sy is approximated by equation (26) within the range of the closed interval [Yv₀, Yv₁] as Yv.

At that time, a difference between the value of the function Sx and an approximation value of the function Sx represented by equation (24), that is, the error by the approximation never exceeds the maximum value of the three values obtained by equations (40) to (42). A difference (approximation error) between the value of the function Sy and an approximation value of the function Sy represented by equation (26) never exceeds the maximum value of the three values obtained by equations (43) to (45).

Herein, the value yus(x, θ)(i) in equation (40) and the value yus(x, θ)(i) in equation (43) are data generated by the execution of the pseudo codes illustrated in FIGS. 6 and 7, respectively. In equations (40) to (45), Xa is the value in 0.1 units and is the value as close to Xv/Fv as possible. Similarly, θa is the value in 0.1 units and is the value as close to θ_{pitch} as possible.

By listing the data regarding the extreme values of partial derivatives of the functions Us(x, y, θ) and Vs(x, y, θ) in this manner, it is possible to quantitatively evaluate the error by the approximation. According to this, it is possible to cut out a partial area of the panoramic image within an allowable range of the approximation error with less calculation.

From above, when the panoramic image is the image projected on the spherical surface, the pixel of the panoramic image may be written in an area from a position (Xv, Yv₀) to a position (Xv, Yv₁) of the screen SC11 (canvas area) for a predetermined fixed value Xv in a following manner.

That is, the approximation calculation of equations (24) and (26) is performed for each position (Xv, Yv) from the position (Xv, Yv₀) to the position (Xv, Yv₁) and the position (Sx, Sy) on the panoramic image corresponding to the position (Xv, Yv) on the screen SC11 is calculated. Then, the pixel value of the pixel in the position (Sx, Sy) on the panoramic image calculated in this manner is written as the pixel value of the pixel in the position (Xv, Yv) on the screen SC11.

When the position (Xv, Yv₁) is not located on an end on a Yv axis direction side of the screen SC11, after the pixels are written from the position (Xv, Yv₀) to the position (Xv, Yv₁), a position (Xv, Yv₁+1) is further made a new position (Xv, Yv₀) and the pixel is repeatedly written.

By the above-described process, it is possible to rapidly cut out a part of the wide panoramic image to display by the simple calculation. Meanwhile, Yv₁ being the Yv coordinate in the position (Xv, Yv₁) on the screen SC11 may be made a maximum Yv coordinate in which the maximum value of equations (40) to (45) described above is not larger than a threshold determined in advance for Yv=Yv₀. That is, the maximum Yv coordinate in which the approximation error is within the allowable range may be made Yv₁. In this manner, it becomes possible to avoid deterioration in quality by the approximation error of the image projected on the screen SC11, thereby obtaining a high-quality image.

On the other hand, when the panoramic image is the image projected on the cylindrical surface, the functions Uc(x, y, and θ) and Vc(x, y, θ) being the functions of x, y, and θ are defined by equation (20) and the approximation equations of Cx and Cy being the functions of θ_{yaw}, θ_{pitch}, Fv, Xv, and Yv defined by equation (4) are considered.

Specifically, suppose that θ_{yaw}, θ_{pitch}, Fv, Xv are fixed to arbitrary values and the function Cx is approximated by equation (28) and the function Cy is approximated by equations (30) within the range of the closed interval [Yv₀, Yv₁] as Yv.

At that time, a difference between the value of the function Cx and an approximation value of the function Cx represented by equation (28), that is, the error by the approximation never exceeds the maximum value of the three values obtained by equations (46) to (48). A difference (approximation error) between the value of the function Cy and the approximation value of the function Cy represented by equation (30) never exceeds the maximum value of the three values obtained by equations (49) to (51).

Herein, the value yuc(x, θ)(i) in equation (46) and the value yuc(x, θ)(i) in equation (49) are data generated by the execution of the pseudo codes illustrated in FIGS. 8 and 9. In equations (46) to (51), Xa is the value in 0.1 units and the value as close to Xv/Fv as possible. Similarly, θa is the value in 0.1 units and is the value as close to θ_{pitch} as possible.

By listing the data regarding the extreme values of partial derivatives of Uc(x, y, θ) and the function Vc(x, y, θ) in this manner, it is possible to quantitatively evaluate the error by the approximation. According to this, it is possible to cut out a partial area of the panoramic image within an allowable range of the approximation error with less calculation.

From above, when the panoramic image is the image projected on the cylindrical surface, the pixel of the panoramic image may be written in the area from the position (Xv, Yv₀) to the position (Xv, Yv₁) of the screen SC11 for a predetermined fixed value Xv in a following manner.

That is, the approximation calculation of equations (28) and (30) is performed for each position (Xv, Yv) from the position (Xv, Yv₀) to the position (Xv, Yv₁) and the position (Cx, Cy) on the panoramic image corresponding to the position (Xv, Yv) on the screen SC11 is calculated. Then, the pixel value of the pixel in the position (Cx, Cy) on the panoramic image calculated in this manner is written as the pixel value of the pixel in the position (Xv, Yv) on the screen SC11.

When the position (Xv, Yv₁) is not located on an end on a Yv axis direction side of the screen SC11, after the pixels are written from the position (Xv, Yv₀) to the position (Xv, Yv₁), a position (Xv, Yv₁+1) is further made a new position (Xv, Yv₀) and the pixel is repeatedly written.

By the above-described process, it is possible to rapidly cut out a part of the wide panoramic image to display by the simple calculation. Meanwhile, Yv₁ being the Yv coordinate in the position (Xv, Yv₁) on the screen SC11 may be made the maximum Yv coordinate in which the maximum value of equations (46) to (51) described above is not larger than the threshold determined in advance for Yv=Yv₀.

### First Embodiment

### Configuration Example of Image Processing Apparatus

Next, a specific embodiment to which this technology is applied is described.

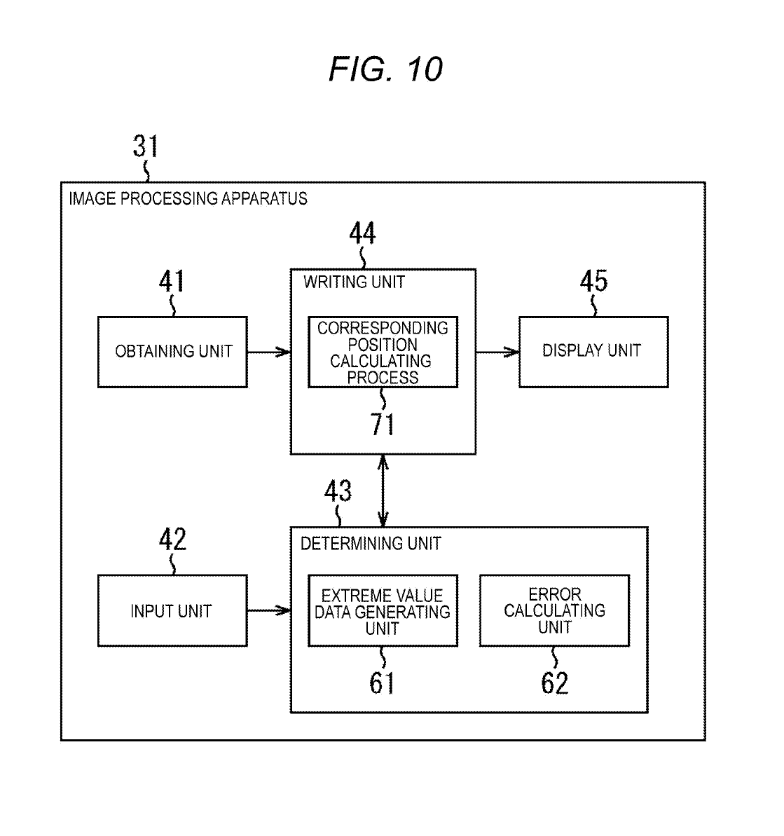

First, a case where a panoramic image is an image projected on a spherical surface is described. In such a case, an image processing apparatus is configured as illustrated in FIG. 10, for example.

An image processing apparatus 31 in FIG. 10 includes an obtaining unit 41, an input unit 42, a determining unit 43, a writing unit 44, and a display unit 45.

The obtaining unit 41 obtains the panoramic image and supplies the same to the writing unit 44. Herein, the panoramic image obtained by the obtaining unit 41 is the image projected on the spherical surface. The input unit 42 supplies a signal corresponding to operation of a user to the determining unit 43.

The determining unit 43 determines an area on a canvas area reserved by the writing unit 44 in which the panoramic image is written by using one approximation function in a case where a partial area of the panoramic image is cut out to be displayed on the display unit 45. The determining unit 43 is provided with an extreme value data generating unit 61 and an error calculating unit 62.

The extreme value data generating unit 61 generates a value of y when an n-th order differential function required for evaluating an approximation error in calculation of a position (Sx, Sy) on the panoramic image takes an extreme value and the extreme value at that time as extreme value data. That is, a value yus(x, θ)(i) when the n-th order differential function takes the extreme value and the extreme value at that time and a value yus(x, θ)(i) of y when the n-th order differential function takes the extreme value and the extreme value at that time are calculated as the extreme value data. The error calculating unit 62 calculates the approximation error in the calculation of the position (Sx, Sy) on the panoramic image based on the extreme value data.

The writing unit 44 generates an image of an area in an eye direction with a focal distance specified by the user in the panoramic image by writing a part of the panoramic image from the obtaining unit 41 in the reserved canvas area while communicating information with the determining unit 43 as needed.

The writing unit 44 is provided with a corresponding position calculating unit 71 and the corresponding position calculating unit 71 calculates a position of a pixel on the panoramic image written in each position of the canvas area. The writing unit 44 supplies an image written in the canvas area (herein, referred to as an output image) to the display unit 45.

The display unit 45 formed of a liquid crystal display and the like, for example, displays the output image supplied from the writing unit 44. The display unit 45 corresponds to the above-described display device. Meanwhile, hereinafter, a size of a display screen of the display unit 45 is Wv pixels in a transverse direction and Hv pixels in a longitudinal direction.

[Description of Image Outputting Process]

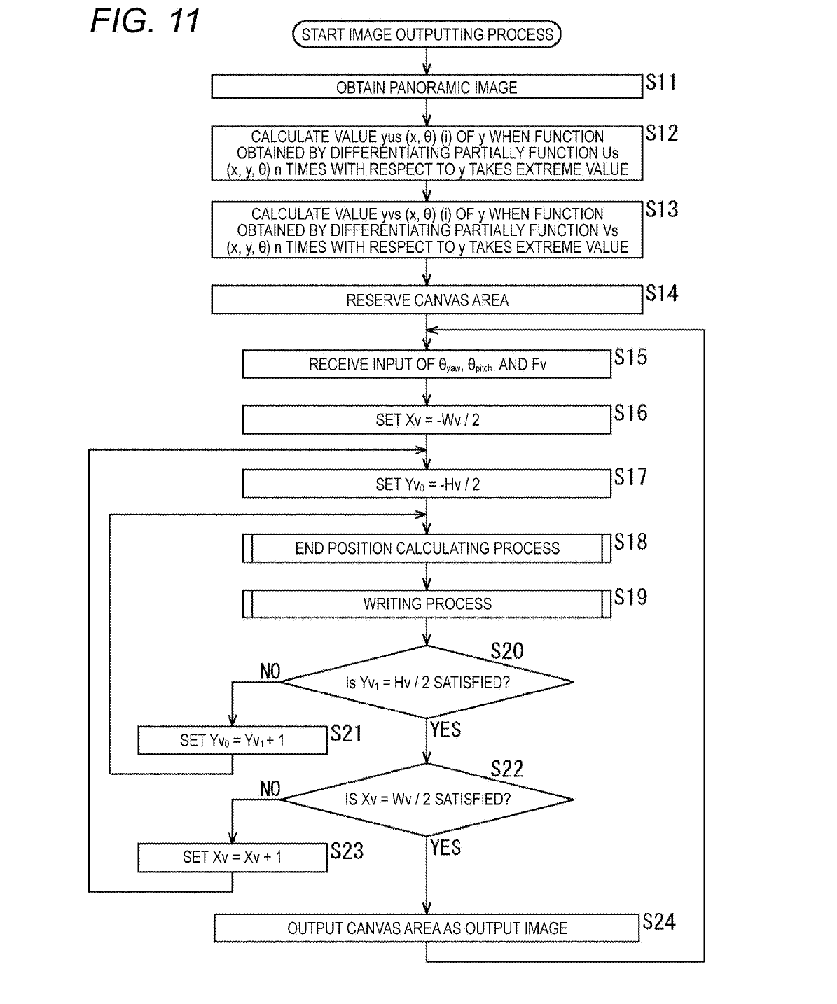

When the panoramic image is supplied to the image processing apparatus 31 and the user provides an instruction to display the output image, the image processing apparatus 31 starts an image outputting process to generate the output image from the supplied panoramic image to output. The image outputting process by the image processing apparatus 31 is hereinafter described with reference to a flowchart in FIG. 11.

At step S11, the obtaining unit 41 obtains the panoramic image and supplies the same to the writing unit 44.

At step S12, the extreme value data generating unit 61 calculates the value yus(x, θ)(i) of y when an n-th order differential function obtained by differentiating partially a function Us(x, y, θ) n times with respect to y takes the extreme value and holds obtained each value yus(x, y, θ)(i) and the extreme value at the value yus(x, θ)(i) as the extreme value data.

Specifically, the extreme value data generating unit 61 executes a pseudo code illustrated in FIG. 6 and makes a value of y when equation (32) or (33) is satisfied the value yus(x, θ)(i) of y when the extreme value is taken.

At step S13, the extreme value data generating unit 61 calculates the value yvs(x, θ)(i) of y when an n-th order differential function obtained by differentiating partially a function Vs(x, y, θ) n times with respect to y takes the extreme value and holds obtained each value yvs(x, θ)(i) and the extreme value at the value yvs(x, θ)(i) as the extreme value data.

Specifically, the extreme value data generating unit 61 executes a pseudo code illustrated in FIG. 7 and makes a value of y when equation (34) or (35) is satisfied the value yvs(x, θ)(i) of y when the extreme value is taken.

The value yus(x, θ)(i) and the value yvs(x, θ)(i) of y and the extreme values at the values of y as the extreme value data obtained in this manner are used in calculation of the approximation error when the position (Sx, Sy) on the panoramic image written in a position (Xv, Yv) on the canvas area (screen) is obtained by approximation. Meanwhile, the extreme value data may also be held in a look-up table format and the like, for example.

At step S14, the writing unit 44 reserves the canvas area for generating the output image in a memory not illustrated. The canvas are corresponds to a virtual screen SC11 illustrated in FIG. 5.

Meanwhile, an XvYv coordinate system is determined by making a central point of the canvas area an original point O′ and a width in a Xv direction (transverse direction) and a height in a Yv direction (longitudinal direction) of the canvas area are set to Wv and Hv, respectively. Therefore, a range of the canvas area in the XvYv coordinate system is represented as −Wv/2≦Xv≦Wv/2 and −Hv/2≦Yv≦Hv/2.

At step S15, the input unit 42 receives an input of an angle θ_{yaw}, an angle θ_{pitch}, and a focal distance Fv. The user operates the input unit 42 to input the eye direction determined by the angles θ_{yaw} and θ_{pitch} and the focal distance Fv. The input unit 42 supplies the angles θ_{yaw} and θ_{pitch} and the focal distance Fv input by the user to the determining unit 43.

At step S16, the writing unit 44 sets an Xv coordinate of a start position of an area in which the panoramic image is written on the canvas area to −Wv/2.

Meanwhile, the panoramic image is sequentially written in the canvas area from an end on a −Yv direction side in a +Yv direction for each area formed of pixels with the same Xv coordinate. An area formed of certain pixels arranged in the Yv direction in the canvas area is made the writing area and a position on the panoramic image corresponding to each position (Xv, Yv) in the writing area is obtained by calculation using one approximation function.

Hereinafter, a position of a pixel on the end on the −Yv direction side of the writing area, that is, that with a smallest Yv coordinate is also referred to as a start position of the writing area and a position of a pixel on an end on the +Yv direction side of the writing area, that is, that with a largest Yv coordinate is also referred to as an end position of the writing area. Hereinafter, the Yv coordinate of the start position of the writing area is set to Yv₀ and the Yv coordinate of the end position of the writing area is set to Yv₁.

At step S17, the writing unit 44 sets the Yv coordinate of the start position of the writing area to Yv₀=−Hv/2.

Therefore, the start position of the writing area on the canvas area is a position (−Wv/2, −Hv/2). That is, a position of an upper left end (apex) in the screen SC11 in FIG. 5 is made the start position of the writing area.

At step S18, the image processing apparatus 31 performs an end position calculating process to calculate a value of Yv₁ being the Yv coordinate of the end position of the writing area.

Meanwhile, in the end position calculating process to be described later, the extreme value data obtained by the processes at steps S12 and S13 is used to determine the end position of the writing area.

At step S19, the image processing apparatus 31 performs a writing process to write the pixel value of the pixel of the panoramic image in the writing area on the canvas area. Meanwhile, in the writing process to be described later, the approximation functions of equations (24) and (26) described above are used and the position (Sx, Sy) on the panoramic image corresponding to each position (Xv, Yv) of the writing area is calculated.

At step S20, the writing unit 44 determines whether the Yv coordinate of the end position of a current writing area satisfies Yv₁=Hv/2.

For example, when the end position of the writing area is located on the end on the +Yv direction side of the canvas area, it is determined that Yv₁=Hv/2 is satisfied. This means that the panoramic image is written to one pixel column formed of the pixels arranged in the Yv direction of the canvas area.

When it is not determined that Yv₁=Hv/2 is satisfied at step S20, the writing in one pixel column on the canvas area is not yet finished, so that the procedure shifts to step S21.

At step S21, the writing unit 44 sets Yv₀ being the Yv coordinate of the start position of the writing area to Yv₁+1.

That is, the writing unit 44 makes a position adjacent to the end position of the current writing area in the +Yv direction the start position of a next new writing area. For example, when a coordinate of the end position of the current writing area is (Xv, Yv), a position a coordinate of which is (Xv, Yv+1) is made the start position of the new writing area.

After the start position of the new writing area is determined, the procedure returns to step S18 and the above-described processes are repeated. That is, the end position of the new writing area is determined and the panoramic image is written in the writing area.

In contrast, when it is determined that Yv₁=Hv/2 is satisfied at step S20, the writing in one pixel column on the canvas area is finished, so that the writing unit 44 determines whether Xv=Wv/2 is satisfied at step S22.

That is, it is determined whether the Xv coordinate of the current writing area is the Xv coordinate on the end on a +Xv direction side of the canvas area. If the position of the current writing area is the position on the end on the +Xv direction side of the canvas area, this means that the panoramic image is written in an entire canvas area.

At step S22, when it is determined that Xv=Wv/2 is not satisfied, that is, when the writing of the panoramic image in the canvas area is not yet finished, the writing unit 44 sets Xv=Xv+1 at step S23. That is, the writing unit 44 makes the Xv coordinate of a position adjacent to the current writing area in the +Xv direction the Xv coordinate of the new writing area.

After the Xv coordinate of the new writing area is determined, the procedure returns to step S17 and the above-described processes are repeated. That is, the start position and the end position of the new writing area are determined and the panoramic image is written in the writing area.

In contrast, when it is determined that Xv=Wv/2 is satisfied at step S22, that is, when the writing of the panoramic image in the canvas area is finished, the writing unit 44 outputs the image of the canvas area as the output image at step S24.

The image output from the writing unit 44 is supplied to the display unit 45 as the output image to be displayed. According to this, the image (output image) in the area in the eye direction with the focal distance specified by the user in the panoramic image is displayed on the display unit 45, so that the user may view the displayed output image.

After the output image is output, the procedure returns to step S15 and the above-described processes are repeated. That is, if the user wants to view another area in the panoramic image, when the user inputs again the eye direction and the focal distance, a new output image is generated to be displayed by the processes at steps S15 to step S24. When the user provides an instruction to finish displaying the output image, the image outputting process is finished.

In the above-described manner, when the user specifies the eye direction and the focal distance, the image processing apparatus 31 writes each pixel of the panoramic image specified by the eye direction and the focal distance in the canvas area to generate the output image. At that time, the image processing apparatus 31 determines the end position of the writing area based on an evaluation result of the approximation error such that quality is not deteriorated and writes the pixel of the panoramic image in the writing area.

According to this, it is possible to easily and rapidly cut out an area in a desired direction in the panoramic image to make the same the output image and to present a high-quality output image.

[Description of End Position Calculating Process]

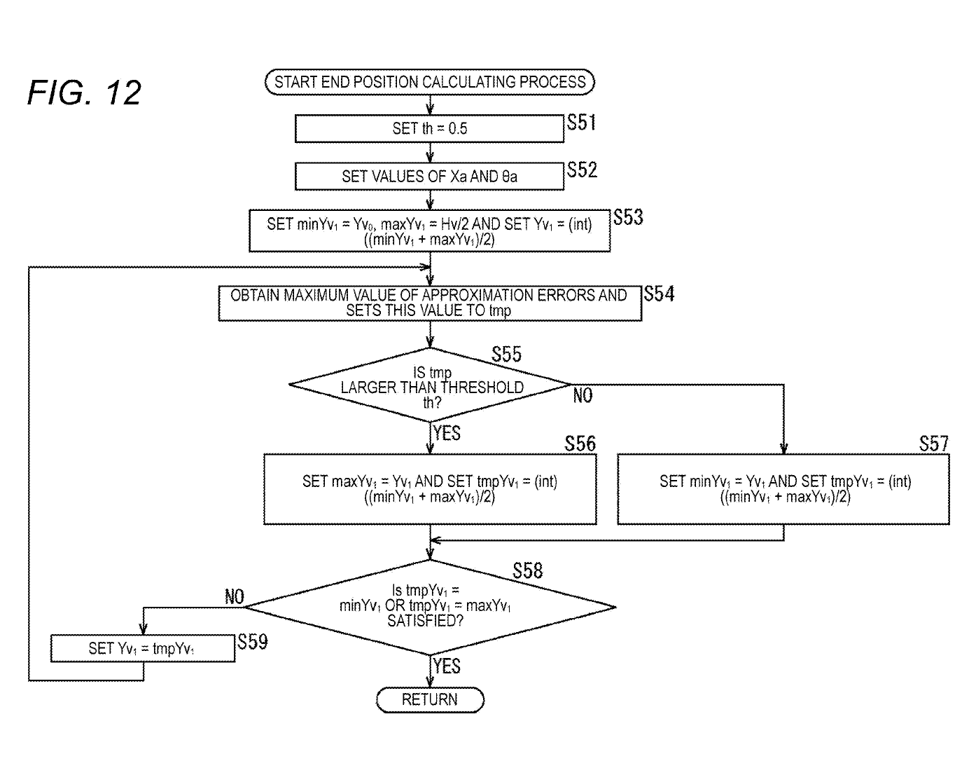

Next, the end position calculating process corresponding to the process at step S18 in FIG. 11 is described with reference to a flowchart in FIG. 12.

At step S51, the determining unit 43 sets a threshold th to 0.5. Herein, the threshold th represents an approximation error allowance in the calculation of the position (Sx, Sy) on the panoramic image by using the approximation function. Meanwhile, a value of the threshold th is not limited to 0.5 and may be any value.

At step S52, the determining unit 43 sets values of Xa and θa. Specifically, the determining unit 43 sets a value the closest to Xv/Fv in 0.1 units as Xa and sets a value the closest to the angle θ_{pitch} in 0.1 units of as θa.

Herein, Xv is a value of the Xv coordinate of the writing area determined by the process at step S16 or S23 in FIG. 11 and Fv and θ_{pitch} are values of the angle θ_{pitch} and the focal distance Fv input by the process at step S15 in FIG. 11.

At step S53, the determining unit 43 sets a parameter indicating a lower limit of the end position of the writing area minYv₁ to Yv₀ and sets a parameter indicating an upper limit thereof maxYv₁ to Hv/2, and sets the Yv coordinate of the end position to Yv₁=(int)((minYv₁+maxYv₁)/2). Meanwhile, the Yv coordinate of the end position herein determined is a temporarily determined provisional value. Herein, (int)(A) is a function to round down a fractional portion of A and output an integer portion thereof.

At step S54, the error calculating unit 62 calculates equations (40) to (45) described above and obtains a maximum value of the approximation errors when Sx and Sy are calculated by the approximation functions and sets an obtained value to tmp.

That is, the error calculating unit 62 calculates the approximation error when Sx is calculated by the approximation function of equation (24) by calculating equations (40) to (42). At that time, the error calculating unit 62 calculates equation (40) by using the extreme value at the value yus(xa, θa)(i) of y held as the extreme value data. Meanwhile, the values set by the process at step S52 are used as the values of Xa and θa in the value yus(xa, θa)(i) of y. When only the value yus(xa, θa)(i) of y is held as the extreme value data, the value (extreme value) of the n-th order differential function is calculated based on the value yus(xa, θa)(i).

Further, the error calculating unit 62 calculates the approximation error when Sy is calculated by the approximation function of equation (26) by calculating equations (43) to (45). At that time, the error calculating unit 62 calculates equation (43) by using the extreme value at the value yvs(xa, θa)(i) of y held as the extreme value data. Meanwhile, the values set by the process at step S52 are used as the values of Xa and θa in the value yvs(xa, θa)(i) of y.

When the error calculating unit 62 obtains the approximation error of Sx and the approximation error or Sy in this manner, this sets a larger one of the approximation errors to the maximum value tmp of the error.

When the maximum value tmp of the error is not larger than the threshold th being the error allowance, this means that the approximation error is within an allowable range for an area from the start position of the writing area to a currently provisionary determined end position of the writing area. That is, deterioration in quality of the output image is unnoticeable even when the position of the panoramic image corresponding to each position of the writing area is obtained by using the same approximation function.

At step S55, the determining unit 43 determines whether the maximum value tmp of the error is larger than the threshold th.

When it is determined that the maximum value tmp is larger than the threshold th at step S55, that is, when the approximation error is larger than the allowance, the determining unit 43 sets the parameter indicating the upper limit of the end position maxYv₁ to Yv₁ at step S56. Then, the determining unit 43 sets tmpYv₁=(int)((minYv₁+maxYv₁)/2).

Herein, (int)(A) is a function to round down a fractional portion of A and output an integer portion thereof. Yv₀ is the Yv coordinate of the start position of the current writing area and Yv₁ is the Yv coordinate of the provisionary determined end position of the current writing area.

Therefore, the Yv coordinate of an intermediate position between the lower limit of the current end position and the upper limit of the end position is set to tmpYv₁. After tmpYv₁ is obtained, the procedure shifts to step S58.

In contrast, when it is determined that the maximum value tmp is not larger than the threshold th at step S55, that is, when the approximation error is not larger than the allowance, the determining unit 43 sets the parameter indicating the lower limit of the end position minYv₁ to Yv₁ at step S57. Then, the determining unit 43 sets tmpYv₁=(int)((minYv₁+maxYv₁)/2).

Herein, (int)(A) represents a function to output the integer portion of A. Yv₁ represents the Yv coordinate of the provisionary determined end position of the current writing area. Therefore, the Yv coordinate of an intermediate position between the lower limit of the current end position and the upper limit of the end position is set to tmpYv₁. After tmpYv₁ is obtained, the procedure shifts to step S58.

When tmpYv₁ is obtained at step S56 or S57, the determining unit 43 determines whether tmpYv₁=minYv₁ or tmpYv₁=maxYv₁ is satisfied at step S58. That is, it is fixed whether Yv₁ being the Yv coordinate of the end position is determined by convergence of a bisection method performed by the process at steps S55 to S57.

When it is determined that any of tmpYv₁=minYv₁ and tmpYv₁ to maxYv₁ is not satisfied at step S58, the determining unit 43 sets Yv₁ to tmpYv₁ at step S59. That is, a value of tmpYv₁ calculated at step S56 or S57 is made a new provisional Yv coordinate of the end position of the writing area.

After Yv₁=tmpYv₁ is satisfied, the procedure returns to step S54 and the above-described processes are repeated.

In contrast, when it is determined that tmpYv₁=minYv₁ or tmpYv₁=maxYv₁ is satisfied at step S58, the determining unit 43 determines a currently provisionary determined value of Yv₁, as the Yv coordinate of the end position of the writing area.

The determining unit 43 supplies information indicating the start position and the end position of the writing area to the writing unit 44 and the end position calculating process is finished. After the end position calculating process is finished, the procedure shifts to step S19 in FIG. 11. Meanwhile, at that time, the angle θ_{yaw}, the angle θ_{pitch}, and the focal distance Fv input by the user are also supplied from the determining unit 43 to the writing unit 44 as needed.

In the above-described manner, the image processing apparatus 31 obtains the error in the calculation of the position (Sx, Sy) by the approximation function by using the extreme value data and determines the end position of the writing area based on the error.

According to the image processing apparatus 31, it is possible to rapidly determine the writing area in which the approximation error is within the allowable range by a simple operation to calculate equations (40) to (45) described above by using the extreme value data by generating the extreme value data in advance.

[Description of Writing Process]

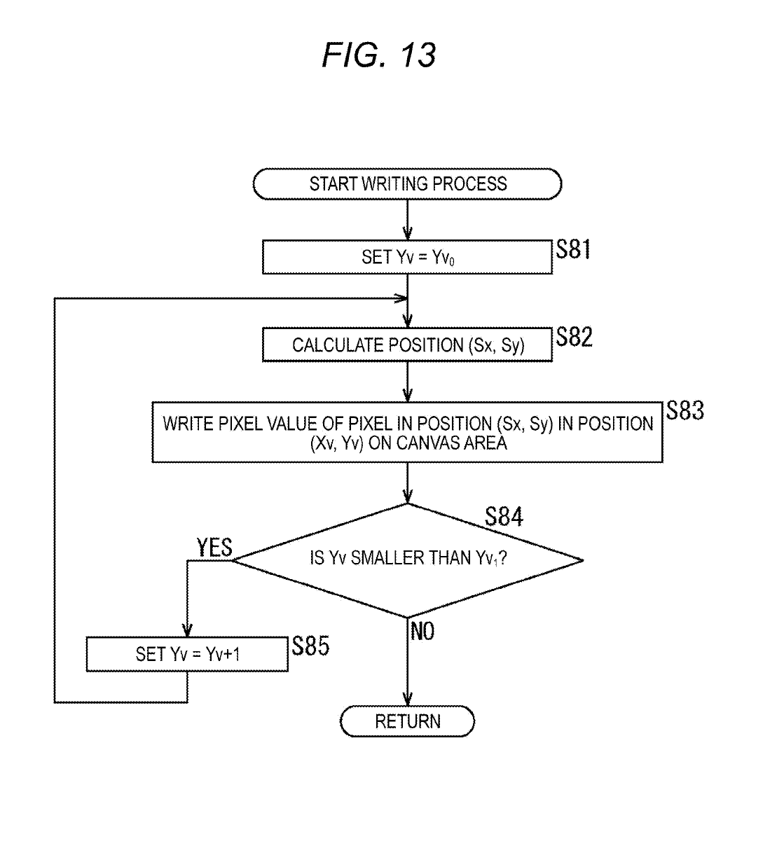

Next, the writing process corresponding to the process at step S19 in FIG. 11 is described with reference to a flowchart in FIG. 13.

At step S81, the writing unit 44 sets the Yv coordinate of a position of a writing target in which the writing is performed from now in the writing area on the canvas area to Yv₀ based on the information indicating the start position and the end position of the writing area supplied from the determining unit 43.

That is, the Yv coordinate of the position (Xv, Yv) of the writing target on the canvas area is set to Yv₀ being the Yv coordinate of the start position of the writing area. Meanwhile, the Xv coordinate of the position (Xv, Yv) of the writing target is set to the Xv coordinate determined by the process at step S16 or S23 in FIG. 11. Therefore, in this case, the start position of the writing area is the position (Xv, Yv) of the writing target.

At step S82, the corresponding position calculating unit 71 calculates equations (24) and (26) described above, thereby calculating the position (Sx, Sy) on the panoramic image corresponding to the position (Xv, Yv) of the writing target. At that time, the corresponding position calculating unit 71 calculates equations (24) and (26) by using the information of the start position and the end position, the angle θ_{yaw}, the angle θ_{pitch}, and the focal distance Fv supplied from the determining unit 43.

At step S83, the writing unit 44 makes the pixel value of the pixel of the panoramic image in the position (Sx, Sy) calculated by the process at step S82 the pixel value of the pixel of the position (Xv, Yv) of the writing target and writes the same in the position of the writing target on the canvas area.

At step S84, the writing unit 44 determines whether the Yv coordinate of the position (Xv, Yv) of the writing target is smaller than Yv₁ being the Yv coordinate of the end position of the writing area. That is, it is determined whether the pixel of the panoramic image is written for each pixel in the writing area.

When it is determined that the Yv coordinate of the position of the writing target is smaller than Yv₁ being the Yv coordinate of the end position at step S84, the writing unit 44 sets the Yv coordinate of the position of the writing target to Yv=Yv+1 at step S85.

That is, the writing unit 44 makes a position adjacent to the position of the current writing target in the +Yv direction on the canvas area a position of a new writing target. Therefore, when the position of the current writing target is (Xv, Yv), the position of the new writing target is (Xv, Yv+1).

After the position of the new writing target is determined, the procedure returns to step S82 and the above-described processes are repeated.

In contrast, when it is determined that the Yv coordinate of the position of the writing target is not smaller than Yv₁ being the Yv coordinate of the end position at step S84, the pixel of the panoramic image is written in all positions in the writing area, so that the writing process is finished. After the writing process is finished, the procedure shifts to step S20 in FIG. 11.

In the above-described manner, the image processing apparatus 31 calculates the position on the panoramic image in which there is the pixel to be written in the position of the writing target by using the approximation function to write in the writing area. In this manner, it is possible to rapidly write by simple calculation by obtaining the position on the panoramic image corresponding to the position of the writing target by using the approximation function.

For example, when the position on the panoramic image corresponding to the position of the writing target is obtained by calculation of equation (3) described above, complicated calculation such as an operation of a trigonometric function and division is required, so that an operational amount is enormous and a processing speed slows down.

In contrast, the image processing apparatus 31 may obtain the position on the panoramic image corresponding to the position of the writing target by the n-th order polynomial such as equations (24) and (26), so that the processing speed may be improved.

### Second Embodiment

### Configuration Example of Image Processing Apparatus

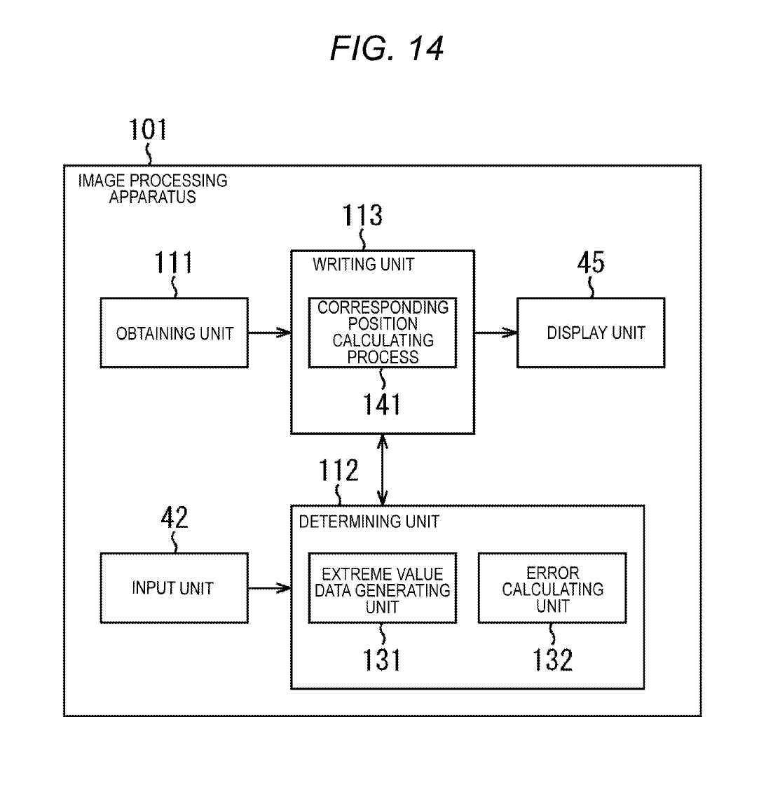

Next, an embodiment in a case where a panoramic image is an image projected on a cylindrical surface is described. In such a case, an image processing apparatus is configured as illustrated in FIG. 14, for example.

An image processing apparatus 101 in FIG. 14 includes an obtaining unit 111, an input unit 42, a determining unit 112, a writing unit 113, and a display unit 45. Meanwhile, in FIG. 14, the same reference numeral is assigned to a part corresponding to that in FIG. 10 and the description thereof is omitted.

The obtaining unit 111 obtains the panoramic image and supplies the same to the writing unit 113. Herein, the panoramic image obtained by the obtaining unit 111 is the image projected on the cylindrical surface.

The determining unit 112 determines an area on a canvas area reserved by the writing unit 113 in which the panoramic image is written by using one approximation function in a case where a partial area of the panoramic image is cut out to be displayed on the display unit 45. The determining unit 112 is provided with an extreme value data generating unit 131 and an error calculating unit 132.

The extreme value data generating unit 131 generates a value of y when an n-th order differential function required for evaluating an approximation error in calculation of a position (Cx, Cy) on the panoramic image takes an extreme value and the extreme value at that time as extreme value data. That is, a value yuc(x, θ)(i) and a value yuc(x, θ)(i) of y when the n-th order differential function takes the extreme value are calculated as the extreme value data. The error calculating unit 132 calculates the approximation error in the calculation of the position (Cx, Cy) on the panoramic image based on the extreme value data.

The writing unit 113 generates an image of an area in an eye direction with a focal distance specified by a user in the panoramic image by writing the panoramic image from the obtaining unit 111 in the reserved canvas area while communicating information with the determining unit 112 as needed.

The writing unit 113 is provided with a corresponding position calculating unit 141 and the corresponding position calculating unit 141 calculates a position of a pixel on the panoramic image written in each position of the canvas area.

[Description of Image Outputting Process]

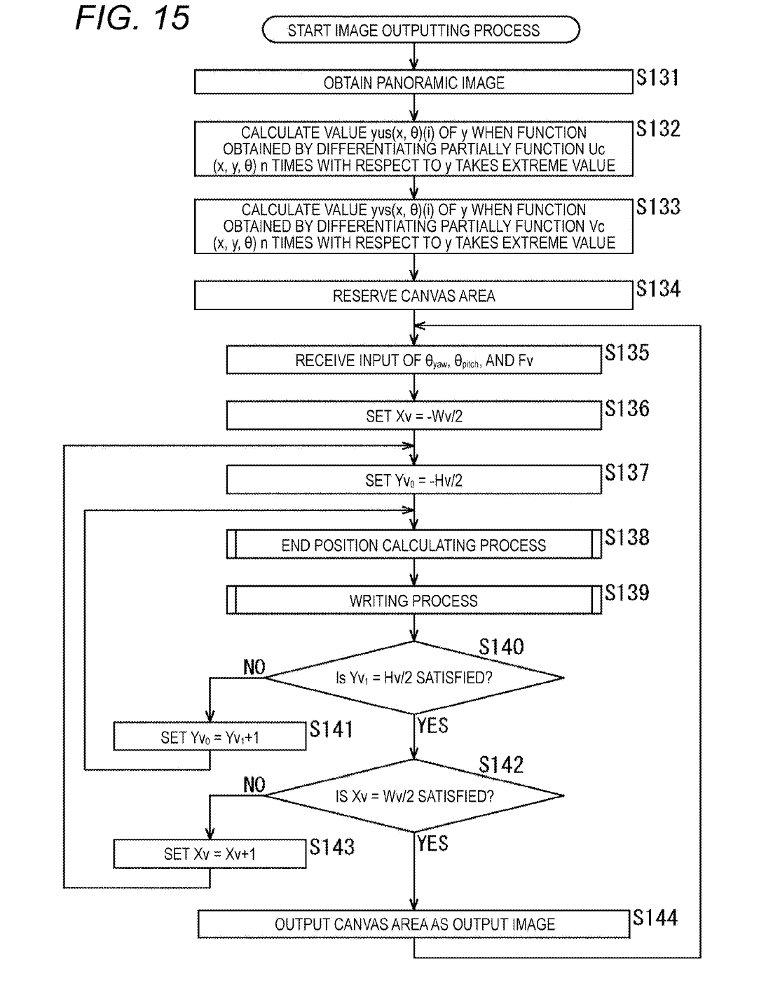

When the panoramic image is supplied to the image processing apparatus 101 and the user provides an instruction to display an output image, the image processing apparatus 101 starts an image outputting process to generate the output image from the supplied panoramic image to output. Hereinafter, the image outputting process by the image processing apparatus 101 is described with reference to a flowchart in FIG. 15.

At step S131, the obtaining unit 111 obtains the panoramic image and supplies the same to the writing unit 113.

At step S132, the extreme value data generating unit 131 calculates the value yuc(x, θ)(i) of y when an n-th order differential function obtained by differentiating partially a function Uc(x, y, θ) n times with respect to y takes the extreme value and holds obtained each value yuc(x, θ)(i) and the extreme value at the value yuc(x, θ)(i) as the extreme value data.

Specifically, the extreme value data generating unit 131 executes a pseudo code illustrated in FIG. 8 and makes a value of y when equation (36) or (37) is satisfied the value yuc(x, θ)(i) of y when the extreme value is taken.

At step S133, the extreme value data generating unit 131 calculates the value yvc(x, θ)(i) of y when an n-th order differential function obtained by differentiating partially a function Vc(x, y, θ) n times with respect to y takes the extreme value and holds obtained each value yvc(x, θ)(i) and the extreme value at the value yvc(x, θ)(i) as the extreme value data.

Specifically, the extreme value data generating unit 131 executes a pseudo code illustrated in FIG. 9 and makes a value of y when equation (38) or (39) is satisfied the value yvc(x, θ)(i) of y when the extreme value is taken.

The value yuc(x, θ)(i) and the value yvc(x, θ)(i) of y and the extreme values at the values of y as the extreme value data obtained in this manner are used in calculation of the approximation error when the position (Cx, Cy) on the panoramic image written in a position (Xv, Yv) on the canvas area (screen) is obtained by approximation. Meanwhile, the extreme value data may also be held in a look-up table format and the like, for example.

After the extreme value data is obtained, processes at steps S134 to S137 are performed; the processes are similar to processes at steps S14 to S17 in FIG. 11, so that the description thereof is omitted.

At step S138, the image processing apparatus 101 performs an end position calculating process to calculate a value of Yv₁ being a Yv coordinate of an end position of a writing area.

Meanwhile, in the end position calculating process to be described later, the extreme value data obtained by the processes at steps S132 and S133 is used and the end position of the writing area is determined.

At step S139, the image processing apparatus 101 performs a writing process to write a pixel value of the pixel of the panoramic image in the writing area on the canvas area. Meanwhile, in the writing process to be described later, the position (Cx, Cy) on the panoramic image corresponding to each position (Xv, Yv) of the writing area is calculated by using the approximation functions of equations (28) and (30) described above.

After the writing process is performed, processes at steps S140 to S144 are performed; the processes are similar to processes at steps S20 to S24 in FIG. 11, so that the description thereof is omitted. When the user provides an instruction to finish displaying the output image, the image outputting process is finished.

In the above-described manner, the image processing apparatus 101 generates the output image to output when the user specifies the eye direction and the focal distance. At that time, the image processing apparatus 101 determines the end position of the writing area based on an evaluation result of the approximation error such that quality is not deteriorated and writes the pixel of the panoramic image in the writing area.

According to this, it is possible to easily and rapidly cut out an area in a desired direction in the panoramic image to make the same the output image and to present a high-quality output image.

[Description of End Position Calculating Process]

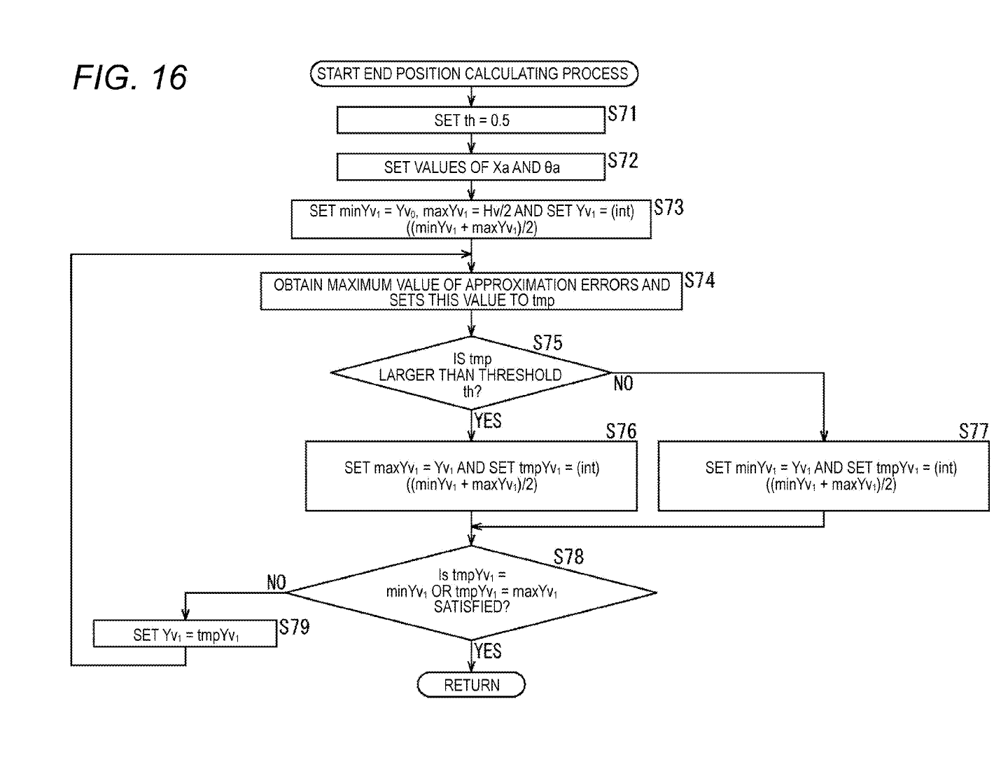

Next, the end position calculating process corresponding to the process at step S138 in FIG. 15 is described with reference to a flowchart in FIG. 16.

Meanwhile, processes at steps S71 to S73 are similar to processes at steps S51 to S53 in FIG. 12, so that the description thereof is omitted.

At step S74, the error calculating unit 132 obtains a maximum value of the approximation errors when Cx and Cy are calculated by the approximation functions by calculating equations (46) to (51) described above and sets an obtained value to tmp.

That is, the error calculating unit 132 calculates the approximation error when Cx is calculated by the approximation function of equation (28) by calculating equations (46) to (48). At that time, the error calculating unit 132 calculates equation (46) by using the extreme value of the value yuc(xa, θa)(i) of y held as the extreme value data. Meanwhile, values set by the process at step S72 is used as values of Xa and θa in the value yuc(xa, θa)(i) of y.

The error calculating unit 132 calculates the approximation error when Cy is calculated by the approximation function of equation (30) by calculating equations (49) to (51). At that time, the error calculating unit 132 calculates equation (49) by using the extreme value of the value yvc(xa, θa)(i) of y held as the extreme value data. Meanwhile, values set by the process at step S72 are used as the values of Xa and θa in the value yvc(xa, θa)(i) of y.

When the error calculating unit 132 obtains the approximation error of Cx and the approximation error of Cy in this manner, this sets a larger one of the approximation errors to the maximum value tmp of the error.

After the maximum value tmp of the error is obtained, processes at steps S75 to S79 are performed and the end position calculating process is finished; the processes are similar to processes at steps S55 to S59 in FIG. 12, so that the description thereof is omitted.

After the end position calculating process is finished, the procedure shifts to step S139 in FIG. 15. Meanwhile, an angle θ_{yaw}, an angle θ_{pitch}, and a focal distance Fv input by the user are supplied together with information of a start position and the end position of the writing area from the determining unit 112 to the writing unit 113 as needed.

In the above-described manner, the image processing apparatus 101 obtains the error in the calculation of the position (Cx, Cy) by the approximation function by using the extreme value data and determines the end position of the writing area based on the error.

According to the image processing apparatus 101, it is possible to rapidly determine the writing area in which the approximation error is within an allowable range by a simple operation to calculate equations (46) to (51) described above by using the extreme value data by generating the extreme value data in advance.

[Description of Writing Process]

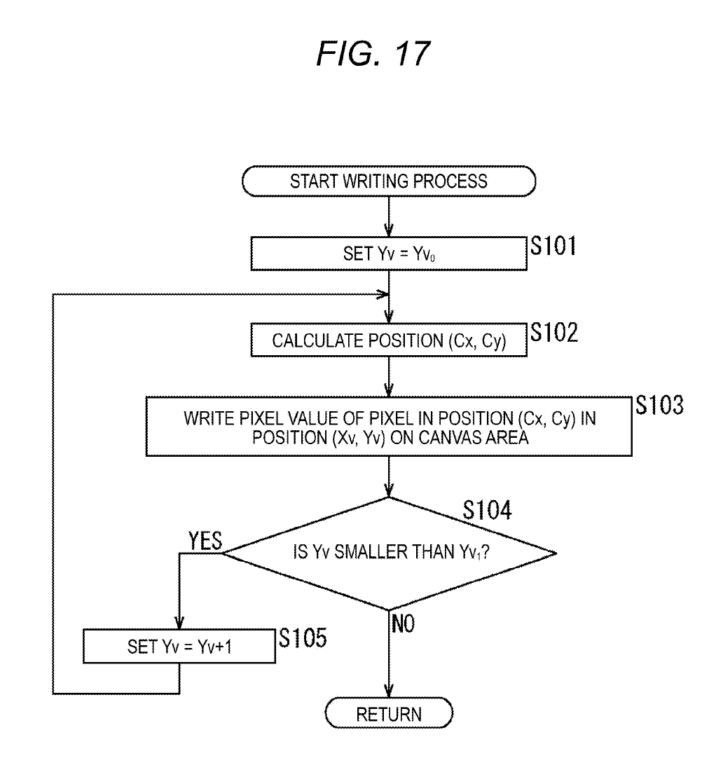

Next, the writing process corresponding to the process at step S139 in FIG. 15 is described with reference to a flowchart in FIG. 17.

Meanwhile, a process at step S101 is similar to a process at step S81 in FIG. 13, so that the description thereof is omitted.

At step S102, the corresponding position calculating unit 141 calculates the position (Cx, Cy) on the panoramic image corresponding to the position (Xv, Yv) of a writing target by calculating equations (28) and (30) described above. At that time, the corresponding position calculating unit 141 calculates equations (28) and (30) by using the information of the start position and end position, the angle θ_{yaw}, the angle θ_{pitch}, and the focal distance Fv supplied from the determining unit 112.

At step S103, the writing unit 113 makes the pixel value of the pixel of the panoramic image in the position (Cx, Cy) calculated by the process at step S102 a pixel value of a pixel of the position (Xv, Yv) of the writing target and writes the same in the position of the writing target on the canvas area.

After the writing in the canvas area is performed, processes at steps S104 and S105 are performed and the writing process is finished; the processes are similar to processes at steps S84 and S85 in FIG. 13, so that the description thereof is omitted. After the writing process is finished, the procedure shifts to step S140 in FIG. 15.

In the above-described manner, the image processing apparatus 101 calculates the position on the panoramic image in which there is the pixel to be written in the position of the writing target by using the approximation function to write in the writing area. In this manner, it is possible to rapidly write by simple calculation by obtaining the position on the panoramic image corresponding to the position of the writing target by using the approximation function.

A series of processes described above may be executed by hardware or by software. When a series of processes is executed by the software, a program configuring the software is installed on a computer. Herein, the computer includes a computer embedded in dedicated hardware, a general-purpose personal computer, for example, capable of executing various functions by install of various programs and the like.

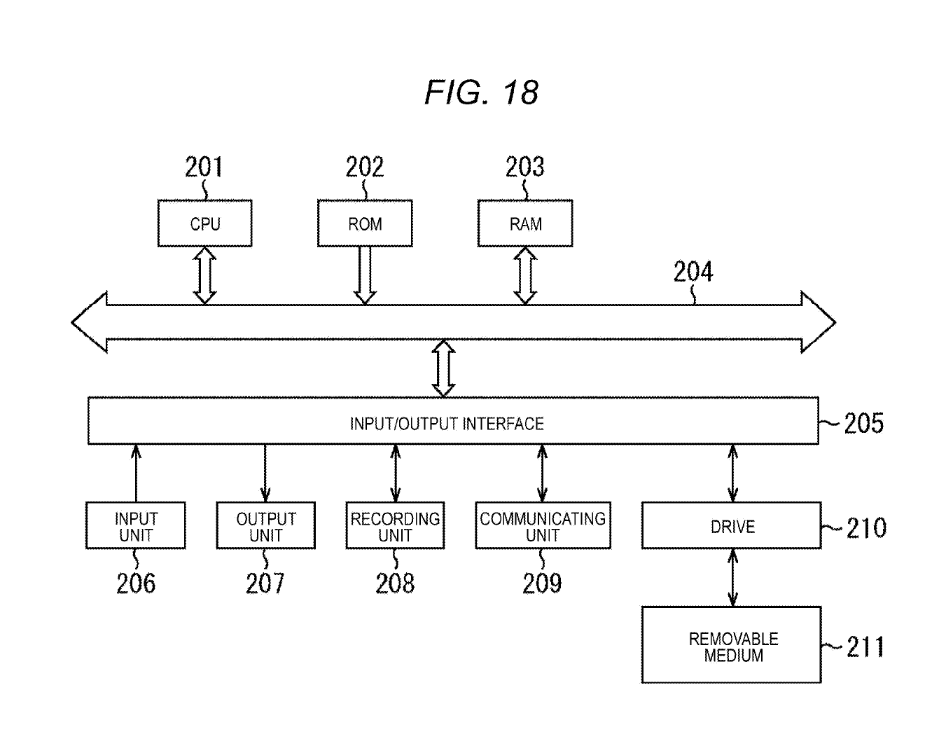

FIG. 18 is a block diagram illustrating a configuration example of the hardware of the computer, which executes the above-described series of processes by the program.

In this computer, a CPU (Central Processing Unit) 201, a ROM (Read Only Memory) 202, and a RAM (Random Access Memory) 203 are connected to one another through a bus 204.

An input/output interface 205 is further connected to the bus 204. An input unit 206, an output unit 207, a recording unit 208, a communicating unit 209, and a drive 210 are connected to the input/output interface 205.

The input unit 206 is formed of a keyboard, a mouse, a microphone and the like. The output unit 207 is formed of a display, a speaker and the like. The recording unit 208 is formed of a hard disk, a non-volatile memory and the like. The communicating unit 209 is formed of a network interface and the like. The drive 210 drives a removable medium 211 such as a magnetic disk, an optical disk, a magnetooptical disk, and a semiconductor memory.

In the computer configured as described above, the CPU 201 loads the program recorded in the recording unit 208 on the RAM 203 through the input/output interface 205 and the bus 204 to execute, for example, and according to this, the above-described series of processes are performed.

The program executed by the computer (CPU 201) may be recorded on a removable medium 211 as a package medium and the like to be provided, for example. The program may be provided through wired or wireless transmission medium such as a local area network, the Internet, and digital satellite broadcasting.

In the computer, the program may be installed on the recording unit 208 through the input/output interface 205 by mounting the removable medium 211 on the drive 210. Also, the program may be received by the communicating unit 209 through the wired or wireless transmission medium to be installed on the recording unit 208. In addition, the program may be installed in advance on the ROM 202 and the recording unit 208.

Meanwhile, the program executed by the computer may be the program of which processes are chronologically performed in order described in this specification or the program of which processes are performed in parallel or at a required timing such as when this is called.

Also, the embodiment of this technology is not limited to the above-described embodiments and various modifications may be made without departing from the scope of this technology.

For example, this technology may be configured as cloud computing to process one function by a plurality of apparatuses together in a shared manner through a network.

Each step described in the above-described flowchart may be executed by one apparatus or may be executed by a plurality of apparatuses in a shared manner.

Further, when a plurality of processes is included in one step, a plurality of processes included in one step may be executed by one apparatus or may be executed by a plurality of apparatuses in a shared manner.

Further, this technology may have a following configuration.

[1]

An image processing apparatus configured to generate an output image having predetermined positional relationship with an input image, the image processing apparatus including:

an extreme value data generating unit configured to generate, based on a function required for calculating an error when a position on the input image corresponding to a position on the output image is obtained by an approximation function, the function having a variable defining the positional relationship and the position on the output image as a variable, data regarding an extreme value of the function;

an error calculating unit configured to calculate, for a current area from a first position to a second position on the output image, the error when the position of the input image corresponding to a position in the current area is obtained by the approximation function based on the data;

a determining unit configured to determine the current area in which the error is not larger than a predetermined threshold; and

an image generating unit configured to generate the output image by obtaining the corresponding position of the input image for each position in the determined current area by using the approximation function and making a pixel value of a pixel of the corresponding position a pixel value of a pixel of the position in the current area.

[2]

The image processing apparatus according to [1], wherein the approximation function is a polynomial approximation function obtained by polynomial expansion of a function indicating the positional relationship around the first position.

[3]

The image processing apparatus according to [2], wherein the approximation function is an (n−1)-th order polynomial approximation function and the function required for calculating the error is a function obtained by n-th order differential of the function indicating the positional relationship.

[4]

The image processing apparatus according to any one of [1] to [3], wherein the variable defining the positional relationship is a direction of the output image seen from a predetermined reference position and a distance from the reference position to the output image.

[5]

The image processing apparatus according to [4], wherein the position on the input image corresponding to a predetermined position on the output image is a position of an intersection between a straight line passing through the predetermined position and the reference position and the input image.

[6]

The image processing apparatus according to any one of [1] to [5], wherein the input image is an image projected on a spherical surface or an image projected on a cylindrical surface.

### REFERENCE SIGNS LIST

31 Image processing apparatus, 43 Determining unit, 44 Writing unit, 61 Extreme value data generating unit, 62 Error calculating unit, 71 Corresponding position calculating unit, 101 Image processing apparatus, 112 Determining unit, 113 Writing unit, 131 Extreme value data generating unit, 132 Error calculating unit, 141 Corresponding position calculating unit

1. An image processing apparatus configured to generate an output image having predetermined positional relationship with an input image, the image processing apparatus comprising:
an extreme value data generating unit configured to generate, based on a function required for calculating an error when a position on the input image corresponding to a position on the output image is obtained by an approximation function, the function having a variable defining the positional relationship and the position on the output image as a variable, data regarding an extreme value of the function;
an error calculating unit configured to calculate, for a current area from a first position to a second position on the output image, the error when the position of the input image corresponding to a position in the current area is obtained by the approximation function based on the data;
a determining unit configured to determine the current area in which the error is not larger than a predetermined threshold; and
an image generating unit configured to generate the output image by obtaining the corresponding position of the input image for each position in the determined current area by using the approximation function and making a pixel value of a pixel of the corresponding position a pixel value of a pixel of the position in the current area.

2. The image processing apparatus according to claim 1, wherein the approximation function is a polynomial approximation function obtained by polynomial expansion of a function indicating the positional relationship around the first position.

3. The image processing apparatus according to claim 2, wherein the approximation function is an (n−1)-th order polynomial approximation function and the function required for calculating the error is a function obtained by n-th order differential of the function indicating the positional relationship.

4. The image processing apparatus according to claim 3, wherein the variable defining the positional relationship is a direction of the output image seen from a predetermined reference position and a distance from the reference position to the output image.

5. The image processing apparatus according to claim 4, wherein the position on the input image corresponding to a predetermined position on the output image is a position of an intersection between a straight line passing through the predetermined position and the reference position and the input image.

6. The image processing apparatus according to claim 5, wherein the input image is an image projected on a spherical surface or an image projected on a cylindrical surface.

7. An image processing method configured to generate an output image having predetermined positional relationship with an input image, the image processing method comprising steps of:
generating, based on a function required for calculating an error when a position on the input image corresponding to a position on the output image is obtained by an approximation function, the function having a variable defining the positional relationship and the position on the output image as a variable, data regarding an extreme value of the function;
calculating, for a current area from a first position to a second position on the output image, the error when the position of the input image corresponding to a position in the current area is obtained by the approximation function based on the data;
determining the current area in which the error is not larger than a predetermined threshold; and
generating the output image by obtaining the corresponding position of the input image for each position in the determined current area by using the approximation function and making a pixel value of a pixel of the corresponding position a pixel value of a pixel of the position in the current area.

8. A program for image processing configured to generate an output image having predetermined positional relationship with an input image, the program configured to allow a computer to execute a process including steps of:
generating, based on a function required for calculating an error when a position on the input image corresponding to a position on the output image is obtained by an approximation function, the function having a variable defining the positional relationship and the position on the output image as a variable, data regarding an extreme value of the function;
calculating, for a current area from a first position to a second position on the output image, the error when the position of the input image corresponding to a position in the current area is obtained by the approximation function based on the data;
determining the current area in which the error is not larger than a predetermined threshold; and
generating the output image by obtaining the corresponding position of the input image for each position in the determined current area by using the approximation function and making a pixel value of a pixel of the corresponding position a pixel value of a pixel of the position in the current area.
